(19) United States
(12) Patent Application Publication
(10) Pub. No.: US 2026/0105819 A1
(43) Pub. Date: Apr. 16, 2026

(54) DETECTION AND NOTIFICATION SYSTEM FOR INDOOR GUNSHOT DETECTION

(71) Applicant: EASTERN MICHIGAN UNIVERSITY, Ypsilanti, MI (US)

(72) Inventor: Tareq Khan, Ypsilanti, MI (US)

(21) Appl. No.: 19/358,774

(22) Filed: Oct. 15, 2025

Related U.S. Application Data
(60) Provisional application No. 63/707,567, filed on Oct. 15, 2024.

(51) Int. Cl. G08B 13/16; G06N 3/0464; G08B 25/00

(52) U.S. Cl. CPC G08B 13/1672; G06N 3/0464; G08B 25/00

(57) ABSTRACT

The disclosure relates to methods and systems for real-time detection of a gunshot. An example method may include capturing, via a detection device, audio of an environment of the detection device. The captured audio may comprise a time-domain audio signal. The method may include transforming, via one or more processors of the detection device, the time-domain audio signal into a Mel-frequency cepstral coefficient (MFCC) image, and determining, via the one or more processors, whether a sound of the gunshot is captured in the audio by applying a convolutional neural network (CNN) to the Mel-frequency cepstral coefficient image. Responsive to determining the sound of the gunshot is captured in the audio, the method may include transmitting, via the detection device, a detection notification to a computing device.

### CROSS REFERENCE TO RELATED APPLICATION

Priority is claimed to U.S. Provisional Application No. 63/707,567 (filed Oct. 15, 2024), which is incorporated herein by reference in its entirety.

### STATEMENT OF GOVERNMENT INTEREST

None.

### BACKGROUND OF THE DISCLOSURE

### Field of the Disclosure

The disclosure relates to methods and systems for real-time detection of a gunshot using a time-domain audio signal captured by a detection device. The time-domain audio signal can be transformed into a Mel-frequency cepstral coefficient (MFCC) image, which can then be used to determine whether a gunshot is detected by applying a convolutional neural network (CNN) to the MFCC image.

### Background

From January 2023 to September 2023 in the USA, the total number of deaths due to gun violence was 31,394—1273 were children between the ages of 0 and 17 and the total number of injuries was 27,408. It is estimated that 31% of public mass shootings occur in the USA, although the USA accounts for only 5% of the world's population. One way to reduce the loss from gun violence is to detect the incident early and notify the police as soon as possible.

There are several commercial products available on the market for gunshot detection.

Some cities utilize companies such as SOUNDTHINKING (formerly ShotSpotter) (Fremont, CA, USA) to detect and localize gunshots on a large scale. In this system, sensor modules are installed around the city in outdoor places—it is not used for indoor crimes. Moreover, these systems are extremely expensive to run and maintain, and gunshot detection involves both automated and manual human analysis. This system costs up to USD 90,000 annually per square mile of coverage. This system is installed by the city authority and not by individuals or institutions for personal use. To reap the benefits of this system, a user needs to move to one of the cities where this system is implemented, which is an overhead.

ZEROEYES provide software solution that integrates with existing security cameras to monitor live video feeds and detect firearms. The system analyzes over 36,000 images per second using an AI-based image classification system trained to identify guns in real-time. If a suspected firearm is detected, the image is sent to the ZEROEYES Operation Center (ZOC), where trained specialists review and confirm the presence of a weapon. Visual coverage is a significant limitation of systems like ZEROEYES compared to sound-based detection systems. Visual detection relies on security cameras having a clear line of sight to the firearm, which means its effectiveness is restricted by the camera placement, angle, lighting conditions, and potential obstructions in the environment. This approach is further slowed by the need for human confirmation of detected firearms before alerts are sent. The system was tested in real-time and it took 25-30 s to receive a smartphone notification after the firearm was visible to the camera. Though they claim this technology can prevent shooting as this detection is pre-gunshot, its practical effectiveness in stopping an actual shooting is limited as firearms are often used within seconds of being drawn from a bag or pocket. It may take several minutes for the police to arrive after the notification is sent, meanwhile, the harm from the first gunshot is already done. Moreover, as camera images are sent to servers, it is a privacy concern because people can be monitored by the company all the time.

AMBERBOX is an indoor gunshot detection system that identifies and tracks gunshots within 3.6 s by analyzing two distinct audio signatures: the muzzle blast and bullet shockwave. In addition to audio detection, it uses infrared sensors to detect the muzzle flash caused by gunpowder combustion. AMBERBOX utilizes machine learning to compare detected sounds against thousands of stored gunshot samples on each detector, enabling it to determine if a gunshot has occurred without needing a line of sight. Given its reliance on stored samples rather than dynamic real-time learning, AMBERBOX could be using K-Nearest Neighbors (KNN) or a similar algorithm that relies on stored examples to make real-time comparisons, rather than learning abstract patterns like state-of-the-art deep learning models do. At inference time, KNN compares the new input to every sample in the stored dataset to find the nearest neighbors, which can become computationally expensive and slow, especially if thousands of samples are stored and need to be compared.

In Samireddy (2017), the method for identifying shotgun blasts relies on the detection of the distinctive muzzle blast signature. The authors developed a specialized filter tailored to recognize shotgun muzzle blasts from the digitized audio signals. Thanhikam (2015) proposes a gunshot noise detection method using Zero-Phase Technique. Both works process the signals in the time domain instead of using state-of-the-art machine learning techniques. The accuracy of their approaches was not reported and no hardware implantation results are presented.

In Hrabina (2018), the authors extracted 11 features from each signal—from a dataset of both gunshot and non-gunshot instances—and used them as input to a neural network for classification. This study employs a neural network with a default MATLAB implementation, featuring one hidden layer containing 10 neurons. The authors report a precision of 69.3%. However, most deep learning approaches with many hidden layers produce better accuracy and precision.

Lopez-Morillas (2016) uses a semi-supervised Non-negative Matrix Factorization (NMF) approach, composed of training and separation stages, to detect gunshots. The result shows that the maximum true positive (TP) was 50% when signal-to-noise ratios (SNR) were 5 dB. No hardware implantation results are presented.

Valenzise (2007) implements two parallel Gaussian Mixture Modelling (GMM) classifiers for discriminating screams from noise and gunshots from noise. Different audio features are used to train the classifiers. The authors report a precision of 93% to detect events when the SNR is 10 dB. Embedded system implantation and notification systems are not included in the work.

In Chen (2006), the authors propose a gunshot event recognition system based on audio and visual features fed into a support vector machine (SVM) classifier. The authors developed a semantic gunshot scene description from video sequences by incorporating gunshot sounds, human emotion, and human activity analysis. The maximum precision reported for gunshots is 73.46%.

Galangque (2019) uses two Artificial Neural Networks (ANN) to detect muzzle blasts and shockwaves from the gunshot sound. A gunshot is recognized if both the muzzle blast and shockwave are identified. A band-pass filter is used to remove undesirable frequencies from the gunshot sound. Then, spatial and frequency domain features are extracted and fed to the ANNs. Each ANN contains only one hidden layer. The system implements an array of four omnidirectional microphones, connected to a commercial data acquisition (DAQ) recording system. MATLAB is then used to analyze and classify the signal. The authors report a 99% accuracy in classifying M16 gunshots from background noise.

In Bajzik (2020), convolutional neural network (CNN) models such as VGG16, InceptionV3, and ResNet18 are trained with transfer learning for gunshot detection. Mel Frequency Cepstral Coefficient (MFCC) features are generated from the audio signals and then fed into the CNN models. An accuracy over 99% is reported for the ResNet18 model for their dataset. The hardware implantation results and notification systems are not presented in the paper.

The work in Morehead (2019) uses a custom CNN model for gunshot classification. Spectrograms are generated from audio signals and fed to the CNN model. The proposed model reports an accuracy of over 99% for their custom dataset. The model is implemented in a low-cost hardware system consisting of a USB microphone, Raspberry Pi board, and a short message service (SMS) modem. When a gunshot is detected, the system sends an SMS alert message to a fixed list of phone numbers. However, the system does not include custom user and device configuration using a smartphone app and plotting the location on a map.

### SUMMARY

In an aspect, the disclosure relates to a method for real-time detection of a gunshot, the method comprising: capturing, via a detection device, audio of an environment of the detection device, the captured audio comprising a time-domain audio signal; transforming, via one or more processors of the detection device, the time-domain audio signal into a Mel-frequency cepstral coefficient image; determining, via the one or more processors, whether a sound of the gunshot is captured in the audio by applying a convolutional neural network (CNN) to the Mel-frequency cepstral coefficient image; and responsive to determining the sound of the gunshot is captured in the audio, transmitting, via the detection device, a detection notification to a computing device.

In a refinement, transforming the time-domain audio signal into the Mel-frequency cepstral coefficient image comprises: partitioning, by the one or more processors, the time-domain audio signal into a plurality of time frames; transforming, by the one or more processors, the time-domain audio signal into a frequency-domain audio signal by applying a fast Fourier transform to each time frame of the plurality of time frames to determine a power spectrum of the frequency-domain audio signal; applying, by the one or more processors, a set of triangular Mel filters to the power spectrum to determine Mel filter energies of respective Mel filters of the set of triangular Mel filters; generating, by the one or more processors, a logarithmic Mel spectrum by applying a logarithmic function to the Mel filter energies; transforming, by the one or more processors, the logarithmic Mel spectrum into Mel-frequency cepstral coefficients by performing a discrete cosine transform of the logarithmic Mel spectrum; and generating, by the one or more processors, the Mel-frequency cepstral coefficient image as a matrix of the Mel-frequency cepstral coefficients of the each time frame.

In another aspect, the disclosure relates to a system for real-time detection of a gunshot, the system comprising: a (centralized) computing device (e.g., a remote/cloud server/database); and at least one detection device comprising: an audio sensor configured to capture audio comprising a time-domain audio signal of an environment of the at least one detection device, and a convolutional neural network (CNN) stored on one or more non-transitory memories and configured to determine a sound of the gunshot based upon a Mel-frequency cepstral coefficient image, wherein the at least one detection device is configured to: transform the time-domain audio signal into a Mel-frequency cepstral coefficient image, and responsive to determining the sound of the gunshot is captured in the audio via the CNN, transmit a detection notification to the (centralized) computing device.

In a refinement, the system further comprises: at least one client device comprising: one or more processors, and one or more non-transitory memories storing processor executable instructions that, when executed by the one or more processors, cause the at least one client device to: (wirelessly) receive a detection notification from the (centralized) computing device, and/or (wirelessly) transmit a confirmation notification to the (centralized) computing device indicating that the detection notification is a valid gunshot detection or a false positive gunshot detection.

In another aspect, the disclosure relates to a method for real-time response to a gunshot detection, the method comprising: receiving from a system as disclosed herein a detection notification that a gunshot has been detected by a detection device in the system; and dispatching a law enforcement response at the environment of the detection device.

In another aspect, the disclosure relates to a non-transitory computer-readable medium storing processor-executable instructions that, when executed by one or more processors, cause the one or more processors to at least: capture audio of an environment, the captured audio comprising a time-domain audio signal; transform the time-domain audio signal into a Mel-frequency cepstral coefficient image; determine whether a sound of a gunshot is captured in the audio by applying a convolutional neural network (CNN) to the Mel-frequency cepstral coefficient image; and responsive to determining the sound of the gunshot is captured in the audio, transmit a detection notification to a computing device.

In another aspect, the disclosure relates to a detection device configured for real-time detection of a gunshot, the detection device comprising: an audio sensor configured to capture audio comprising a time-domain audio signal of an environment of the detection device; and a convolutional neural network (CNN) stored on one or more non-transitory memories and configured to determine a sound of the gunshot based upon a Mel-frequency cepstral coefficient image, wherein the detection device is configured to: transform the time-domain audio signal into a Mel-frequency cepstral coefficient image, and responsive to determining the sound of the gunshot is captured in the audio via the CNN, transmit a detection notification to a centralized computing device.

While the disclosed articles, apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a schematic of a gunshot detection system according to the disclosure.

FIG. 2 illustrates (a) a time-domain gunshot sound; (b) MFCC of the gunshot sound in (a); (c) a time-domain non-gunshot sound of door knocking; and (d) MFCC of the non-gunshot sound in (c).

FIG. 3 illustrates the architecture of a CNN model used in Example 1.

FIG. 4 is a block diagram of gunshot detector device hardware according to the disclosure and used in Example 1.

FIG. 5 is a flowchart of the gunshot detection firmware implemented in the microcontroller used in Example 1.

FIG. 6 illustrates the tables, fields, and relationships of the database used in Example 1, in which the primary key of each table is marked using a key sign on the left side of the field name.

FIG. 7 includes graphs illustrating (a) loss vs. epochs for training and validation datasets; and (b) accuracy vs. epochs for training and validation datasets in Example 1.

FIG. 8 is a confusion matrix of the test dataset for Example 1.

FIG. 9 includes a time domain plot of a gunshot sound (a) and its calculated time domain features: average of absolute values (b), maximum (c), minimum (d), standard deviation (e), and differences between consecutive elements of the average vector (f).

FIG. 10 illustrates (a) MFCC coefficients of a gunshot sound as the frequency domain feature, (b) the frequency domain and the time domain features stacked together where the rows from 0 to 12 are the frequency domain features and the rows from 13 to 17 are the time domain features.

FIG. 11 illustrates the architecture of a CNN model used in Example 2.

FIG. 12 is a block diagram of gunshot detector device hardware according to the disclosure and used in Example 2.

FIG. 13 includes graphs illustrating (a) loss vs. epochs for training and validation datasets; and (b) accuracy vs. epochs for training and validation datasets in Example 2.

FIG. 14 is a confusion matrix of the test dataset for Example 2.

### DETAILED DESCRIPTION

Methods and systems are disclosed for real-time detection of a gunshot. An example method may include capturing, via a detection device, audio of an environment of the detection device. The captured audio may comprise a time-domain audio signal. The method may include transforming, via one or more processors of the detection device, the time-domain audio signal into a Mel-frequency cepstral coefficient (MFCC) image, and determining, via the one or more processors, whether a sound of the gunshot is captured in the audio by applying a convolutional neural network (CNN) to the Mel-frequency cepstral coefficient image. Responsive to determining the sound of the gunshot is captured in the audio, the method may include transmitting, via the detection device, a detection notification to a computing device.

Gun violence and mass shootings kill and injure people, create psychological trauma, damage properties, and cause economic loss. The loss from gun violence can be reduced by early gunshot detection and police notification as soon as possible. As disclosed herein, a gunshot detector device automatically detects indoor gunshot sound and sends the gunshot location to a nearby police station in real time using the Internet. The users of the device and the emergency responders also receive smartphone notifications whenever the shooting happens. This helps emergency responders to quickly arrive at the scene, thus the shooter can be caught, injured people can be taken to the hospital quickly, and lives can be saved. The gunshot detector is an electronic device that can be placed in schools, shopping malls, offices, etc. The device captures gunshot sounds along with timestamps, providing valuable data for post-crime scene analysis. A deep learning model, based on a convolutional neural network (CNN), is trained to classify the gunshot sound from other sounds with at least 98% accuracy. A central server for the emergency responder or police station and smartphone apps is also provided.

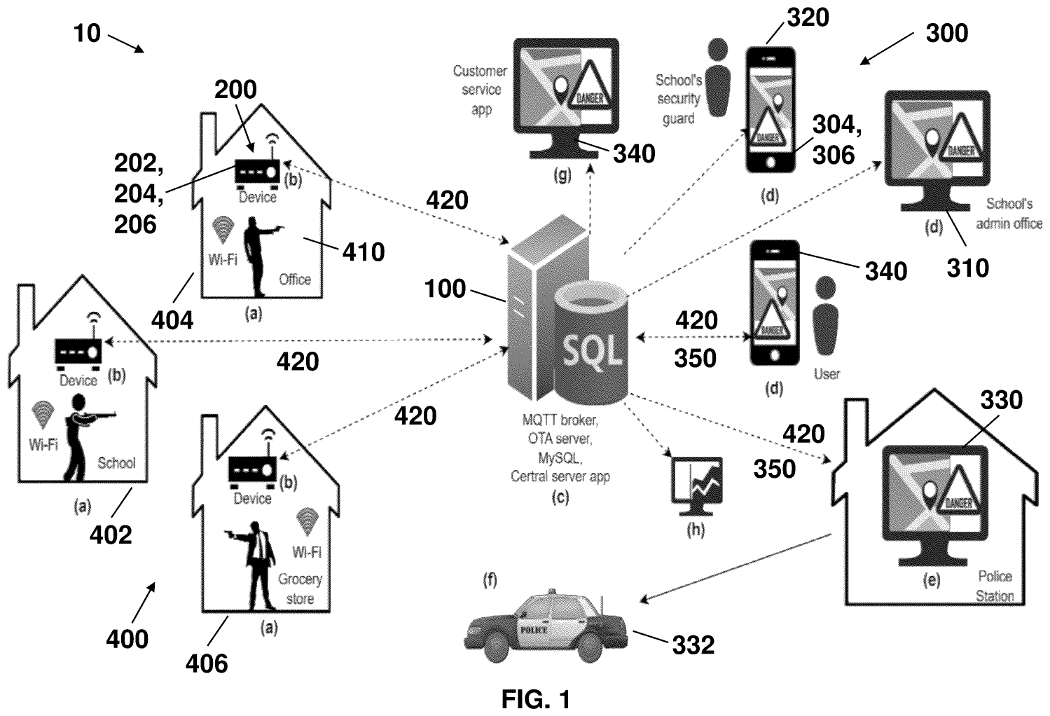

The overall operation of the proposed system is shown in FIG. 1. FIG. 1 illustrates crime scene (a) where the shooting happened. The gunshot detector device (b) is connected to the Wi-Fi of the building. It detects gunshot sounds and sends data to the central server through the Internet to a centralized server (c) using a Transmission Control Protocol/Internet Protocol (TCP/IP) protocol. The crime scene location is marked on the map, event data are saved in the Structured Query Language (SQL) database on the server, and the server software sends notifications using Firebase Cloud Messaging (FCM) to the user's smartphone app or device (d) and the emergency responder's smartphone app or device (e). The emergency responder's car (f) is dispatched.

FIG. 1 illustrates a system 10 for real-time detection of a gunshot according to the disclosure. The system 10 includes a computing device 100, one or more gunshot detection devices 200, and one or more client devices 300. The computing device 100 can be a centralized computing device such as a remote cloud server/database capable of wireless or other networking communication with the detection devices 200 and the client devices 300. The detection device 200 can include an audio sensor 202, one or more processors 204, and one or more non-transitory memories 206. The detection device 200 can capture audio 410 in the form of a time-domain audio signal from an environment 400 in which the detection device 200 is located. The environment 400 can be an indoor location such a school building 402, a private building 404, a public building 406 (e.g., store or government building), and each indoor location can include a plurality of detection devices 200 at different specified locations in the environment 400. The time-domain audio signal is converted into a Mel-frequency cepstral coefficient (MFCC) image using the one or more processors 204, which image is then analyzed via a convolutional neural network (CNN) stored on the non-transitory memories 206 to determine whether the sound of the gunshot is captured or otherwise contained in the audio 410. A positive gunshot detection by the detection device 200 can then be transmitted to the computing device 100 in the form of a detection notification 420 (e.g., via TCP/IP or other (wireless) networking or messaging connection).

The client device 300 can include one or more processors 304, and one or more non-transitory memories 306. The non-transitory memories 306 store processor-executable instructions that, when executed by the one or more processors 304, cause the client device 300 to (wirelessly) receive the detection notification 420 from the computing device 100, and/or (wirelessly) transmit a confirmation notification 350 to the computing device 100. The detection notification 420 can be transmitted from the computing device 100 to any client device 300 (e.g., via FCM or other (wireless) networking or messaging connection). The confirmation notification 350, for example as entered by a user of the client device 300, can indicate that the detection notification 420 is a valid gunshot detection or a false positive gunshot detection. The client devices 300 can include one or more of employee client devices 310, security client devices 320, law enforcement client devices 330, or other user client devices 340. In embodiments, the detection notification 420 can be transmitted to a law enforcement client device 330 along with a request for law enforcement intervention 332 at the environment 400 of the detection device 200.

Advantages and functions of the disclosed systems and methods are summarized as follows: (1) The United States sees the most school shootings in the world. Shootings inside other indoor places such as in homes, shopping malls, clubs, and places of worship are also becoming widespread around the world. The disclosed detection device can be attached to the walls or ceilings of these places—similar to smoke detectors—and they can notify the police as soon as a gunshot is fired. The detection system will help to stop the shooter early and the injured people can be taken to the hospital quickly, thus more lives can be saved. (2) Individuals affected by gun violence, including witnesses, bystanders, and neighbors, may undergo feelings of stress, depression, anxiety, and post-traumatic stress disorder (PTSD). More than 5% of America's children have witnessed a shooting and it causes them psychological distress. The detection device and system can lead the police to the crime scene as soon as possible and can give peace of mind. (3) Solely in 2010, emergency rooms received 36,000 firearm assault victims, with 25,000 requiring hospital admission, resulting in USD 630 million in medical expenses. The overall economic impact of gun violence on the American economy is estimated to be at least USD 229 billion annually. The detection device and system can bring the police quickly to a shooting scene, reducing medical costs and property damage. (4) The disclosed gunshot detection device is mainly targeted for indoor gunshot detection and any user can place it in the rooms of a building and use the corresponding detection system. The hardware cost of the detection device is comparatively small, for example approximately USD 300.

The disclosed methods and systems, in particular as illustrated by Examples 1-2 below, are compared with published related works is shown in Table 1A. A CNN-based deep learning model is trained with the largest dataset in Examples 1-2, and it has high accuracy and precision. Achieving high accuracy on a large dataset indicates that the model is generalized well without overfitting. The disclosed system is implemented in a Jetson Nano-based embedded system which contains GPU and TensorRT engine for fast inferencing, whereas the work in Morehead (2019) uses Raspberry Pi that neither has GPU nor TensorRT support, resulting in slower inferencing. As the disclosed device is connected to Wi-Fi, it can obtain the date and time and record the gunshot sounds with timestamps for post-crime analysis. As described herein, a complete gunshot detection system is implemented consisting of a gunshot detector device; a central server having an SQL database, plotting on a map, data searching, and push notification sending capabilities; and two smartphone apps—for the user and the emergency responders. Users and devices can be configured using smartphone apps considering possible many-to-many relationships. As soon as the gunshot event happens, the smartphone apps receive real-time push notifications with location information plotted in mapping application (e.g., Google Maps).

TABLE 1A
Comparison of Different Methods for Gunshot Detection

| | Hrabina | Morillas | Valenzise | Chen | Galangque | Bajzik | Morehead | Example | Example |
|---|---|---|---|---|---|---|---|---|---|
| | (2018) | (2016) | (2007) | (2006) | (2019) | (2020) | (2019) | 1 | 2 |
| Classifier | ANN | NMF | GMM | SVM | ANN | CNN | CNN | CNN | CNN |
| Dataset size | 11,004 | 215 | — | 459 videos | 917 | 7000 | <90,000 | 670,000 | 155,000 |
| Accuracy | — | — | — | — | 99% | 99% | 99% | 98% | 99% |
| Precision | 69.3% | — | 93% | 73.46% | — | — | — | 98% | 100% |
| Embedded system | no | no | no | no | no | no | yes | yes | yes |
| implementation | | | | | | | | | |
| Record gunshot | no | no | no | no | yes | no | no | yes | yes |
| with timestamp | | | | | | | | | |
| Plot on map | no | no | no | no | no | no | no | yes | yes |
| User and device | no | no | no | no | no | no | no | yes | yes |
| configuration | | | | | | | | | |
| Database | no | no | no | no | no | no | no | yes | yes |
| implementation | | | | | | | | | |
| Smartphone | no | no | no | no | no | no | yes | yes | yes |
| notification | | | | | | | (using | | |
| | | | | | | | SMS) | | |
| Data transmission and | — | no | no | — | — | no | no | no | yes |
| access security | | | | | | | | | |
| OTA update | — | no | no | — | — | no | no | no | yes |
| Device control and | — | no | no | — | — | no | no | no | yes |
| connection status | | | | | | | | | |
| monitoring from | | | | | | | | | |
| smartphone | | | | | | | | | |
| Realtime testing | — | no | no | — | — | no | yes | no | yes |
| with guns | | | | | | | | | |

The disclosed gunshot detection system is mainly targeted at detecting indoor gunshot sounds such as inside schools, banks, shopping malls, stores, houses of worship, etc. For instance, there are 130 k K-12 schools, 75 k bank branches, and 384 k houses of worship in the USA where the system can be used. Unlike the AMBERBOX commercial application, the proposed gunshot detector only stores the deep learning model in the device without storing thousands of sound samples, thus the inferencing time is much faster (less than a second). The disclosed system can help to reduce the time between the first gunshot and contacting the emergency responders. Every second matters in such a gun violence situation. Mortality and health care costs may increase by 7-10% for each minute delay. The disclosed system will notify the police with exact map information within a second. Thus, police can arrive at the crime scene and catch the shooter early, injured people can be taken to the hospital quickly, and more lives can be saved. Unlike smart speakers such as Amazon Alexa or Google Home, the disclosed gunshot detector processes and classifies sound directly on the device, without transmitting the audio to an external server. This ensures that users have no privacy concerns about being monitored without their consent. Table 1B provides a comparison of the disclosed gunshot detection system with commercial products for gunshot detection.

TABLE 1B
Comparison with Commercial Products for Gunshot Detection

| | | | | Present |
|---|---|---|---|---|
| | ShotSpotter | ZeroEyes | AmberBox | Disclosure |
| Indoor/Outdoor | Outdoor | Indoor | Indoor | Indoor |
| Detection Method | Sound | Picture | Sound | Sound |
| Human in the loop | Yes | Yes | No | No |
| Response Time (s) | 60 | 30 | 3.6 | 0.125 |

### EXAMPLES

The following examples illustrate gunshot detection systems and methods according to the disclosure, but are not intended to limit the scope of any claims thereto.

### Example 1

This example illustrates an indoor gunshot detection method and notification system using deep learning according to the disclosure.

Dataset Generation: This example has generated a substantial dataset consisting of 670,000 sound samples, each with a duration of one second. This dataset comprises two distinct classes: ‘gunshot’ and ‘other’. The ‘other’ sounds are any sound other than gunshot sounds, i.e., they are non-gunshot sounds. To classify a sound as a ‘gunshot’ or ‘other’ class, the deep learning model needs to be trained with examples of both classes of sounds. In the developed dataset, each class has 335,000 samples. The gunshot sounds were collected from different online sources such as the BGG dataset, the Free Firearm Sound Effects Library, the Gunshot audio dataset, the Gunshot Audio Forensics Dataset, the Gunshot/Gunfire Audio Dataset, and gunshot sounds from the Urbansound8k Dataset. The ‘other’ sounds were also collected from online sources such as the Urbansound8k Dataset, the ESC-50 Dataset, the FSD50K dataset, and the snoring dataset.

The collected gunshot WAV audio files had a collection of gunshots from different guns such as AK-12, AK-47, IMI Desert Eagle, M4, M16, M249, MG-42, MP5, and Zastava M92. These audio files had different durations. Moreover, these files often contained silence, human talking, environmental sounds, bullet shell falling and trailing sound after a gunshot, etc., for more than one second. These sounds must be removed from the gunshot class samples to make a high-quality dataset and to increase the accuracy of the trained model. To do that, all these files were first joined using WavePad Sound Editor. Then, using the silence threshold function of the sound editor software, silences are removed. However, it was found that this method is not fully accurate and some silences were still there. Then, the joined file was split into equal-sized one-second duration files. As the joined file was not evenly divisible by one second, the last split file was deleted. A valid one-second gunshot sound file is defined that contains at least one starting of a gunshot sound at any place in the one-second duration. To automatically remove silent sound files, a Python code was written that reads the maximum absolute amplitude of each WAV file, compares it with a threshold, and removes the files if it is below the threshold. However, this time-domain approach is still not so accurate to filter out all the silences. To remove the unwanted sounds, all the one-second gunshot sound files, approximately 20,000 samples, were manually heard by humans and filtered. This manual effort is necessary to make the dataset a high-quality dataset and to reduce false alarms from the trained model. As the goal is to develop a gunshot detector embedded system hardware with a microphone, the dataset is generated from the same microphone that will be used in the embedded system. To do that the one-second gunshot sounds were merged into a single file, played from a computer, recorded in another computer using the same microphone that will be used in the embedded system, and then split the recorded file into one-second files.

Data augmentation in deep learning for sound is a technique where new training examples are created by slightly modifying the existing ones. This helps the model learn more effectively from the data it has. For sound, it means changing aspects such as pitch and speed; or adding background noise to audio recordings. By doing this, the model is provided with a broader range of examples, making it better at recognizing different variations in sound in real-world scenarios, ultimately improving its performance in tasks such as speech recognition or sound classification. In this example, the audio data augmentation library is used to generate more sound samples. For each sample, 20 additional augmented samples were generated by: slightly shifting the signal to the left and right in the time axis, changing the tone, and the speed. The empty places were filled with silence in those files.

The collected ‘other’ files contain non-gunshot sounds such as silence, mild noise, clock ticking, the door opening and closing, toilet flushing, the siren of an emergency vehicle, rain, streetcar, people talking, baby crying, animal voices, washing machine, and vacuum cleaner. This dataset contains possible false alarms for gunshots such as fireworks, can opening, door knocking, glass breaking, clapping, drums, and thunderstorms. Gunshot sounds from some of these datasets were identified from the dataset metadata and automatically removed using Python scripts. These audio files had different durations. To make one-second files: all these files were first joined, and then the joined file was split into equal-sized one-second duration files. The last split file was deleted as the joined file was not evenly divisible by one second.

Normalization and Feature Extraction: The audio files are then normalized with the min-max normalization method using the Pydub library. The stereo audio samples are made single channel audio by taking only the left channel data. Then, feature extraction is performed by converting the time-domain audio signal to the Mel Frequency Cepstral Coefficients (MFCCs). The main principle behind MFCC is to condense essential information into a concise set of coefficients, inspired by the human ear's auditory perception. To compute the MFCC, the time-domain audio signal is first partitioned into frames lasting 20-40 milliseconds each. For each frame, the power spectrum is determined. Subsequently, triangular-shaped Mel filter banks are computed and applied to the power spectra, generating a spectrogram. Notably, the human ear exhibits superior sensitivity to subtle pitch changes in lower frequencies (below 1 kHz) compared to higher frequencies. To account for this sensitivity discrepancy, the first ten filters in the Mel filter bank are linearly spaced approximately 100, 200, . . . , and 1000 Hz. Beyond 1 kHz, these filters are distributed according to the logarithmic Mel scale. Following this, the logarithm of all filter bank energies is calculated, and their discrete cosine transform (DCT) is performed to decorrelate the filter bank coefficients. This process effectively captures the salient characteristics of the sound, making it suitable for subsequent sound classification tasks.

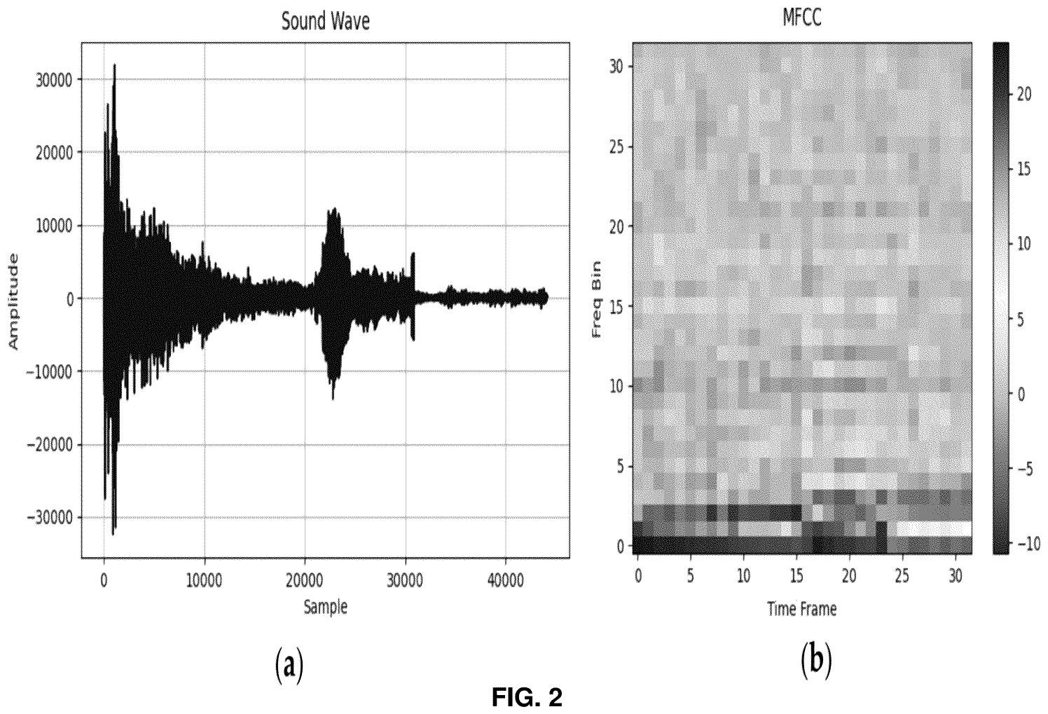

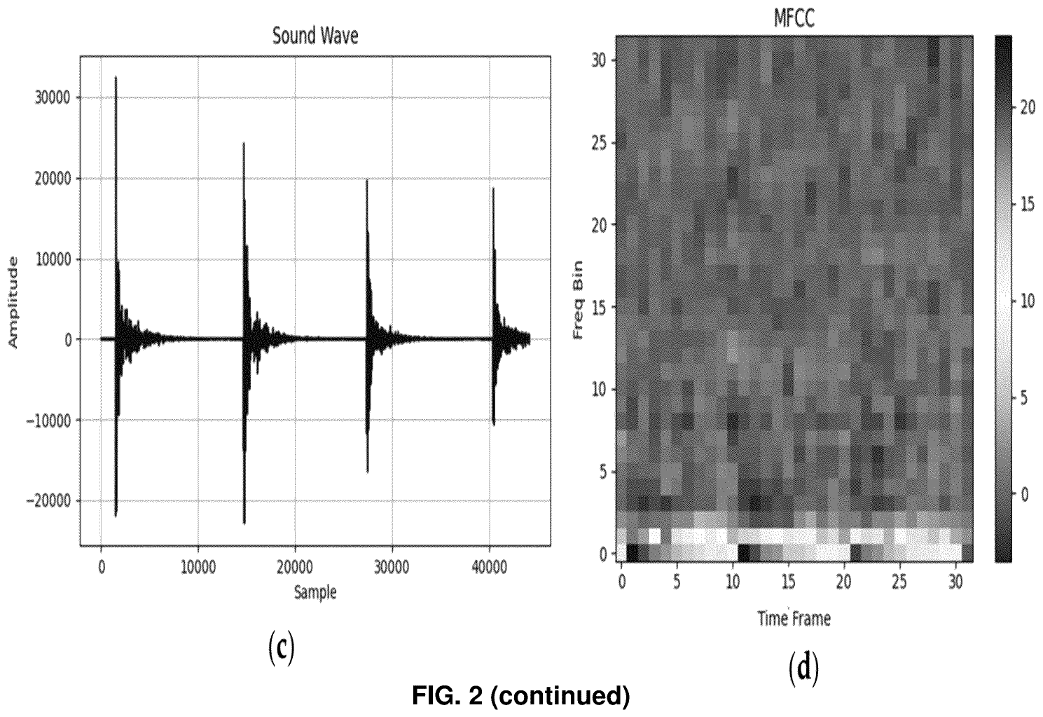

In this example, the sound sample is segmented into frames lasting 30 milliseconds each. To extract meaningful features, the MFCCs are computed using the SpeechPy library. For this purpose, 32 filters are employed in the filter bank, and the Fast Fourier Transform (FFT) is applied with 512 points. The resulting MFCC representation consists of 32 cepstral coefficients. In FIG. 2, examples of a gunshot sample and a non-gunshot sample are presented both in the time domain and their corresponding MFCC representations. After applying MFCC calculations, the one-dimensional time-domain sound signal is transformed into a two-dimensional signal with a size of 32×32, effectively resembling an image. Leveraging this MFCC-based image representation, image classification deep learning architectures can be used, such as convolutional neural networks (CNNs), to classify the sample images. Consequently, a dataset comprising 670,000 MFCC images is assembled from the sound samples, serving as the input for the deep learning network during the classification process. The MFCC data and their associated class labels are then randomly shuffled maintaining the correspondence between data and label.

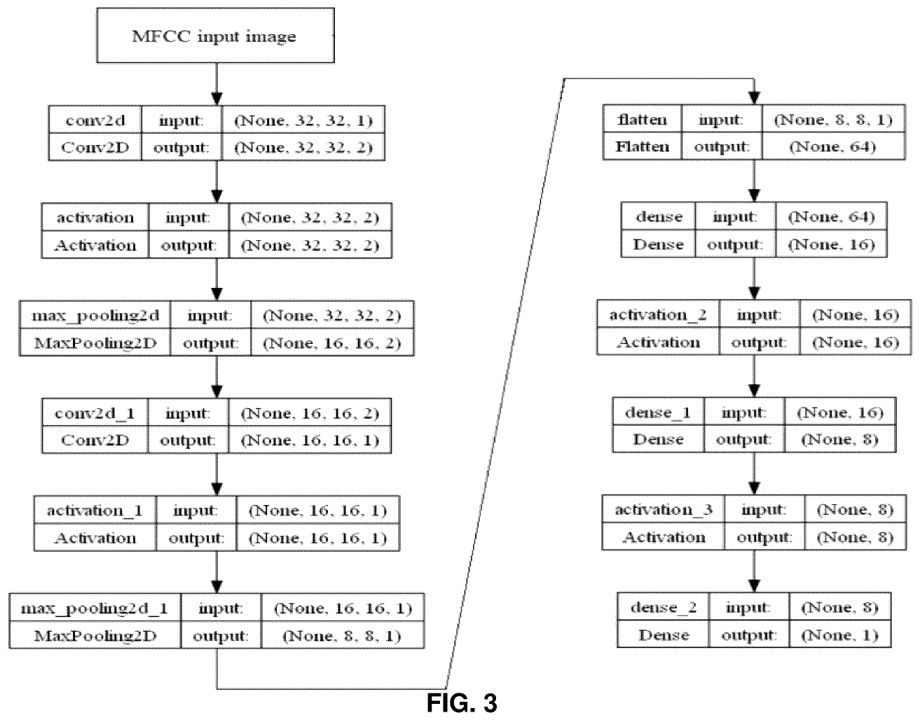

Convolutional Neural Network Architecture: Several iterations are made to find a model that can fit the dataset well and also has sufficient capacity (i.e., parameters) to avoid overfitting. To find the right model capacity, first training is performed using a model with large parameters. The batch size is set as large as possible until memory issues are reported. Then, gradually the model capacity is reduced until fitting becomes difficult. The learning rate and learning rate decay parameters were reduced when the validation loss was not decreasing for a long-time during training. Finally, a deep learning model, as shown in FIG. 3, is used to classify the sound as gunshot or as other. In this example, the sounds are converted to images as discussed in above. and shown in FIG. 2. The one-dimensional time-domain sound samples are converted to two-dimensional frequency domain MFCC image representation. These MFCC images are used as input of the deep-learning-based classifier to classify the MFCC images, which are actually representations of sounds. The different layers and the optimizer of the model are briefly described below.

MFCC Input Image: The MFCC image is structured as a tensor with dimensions of (32, 32, 1). To ensure compatibility with deep learning models, the pixel data type undergoes conversion to a floating-point format. For the purpose of pixel value normalization, the mean and standard deviation of the training dataset are calculated and stored in a separate file. Subsequently, each pixel value in all dataset images is normalized by subtracting the mean and dividing by the standard deviation.

The Convolutional Layer: A 2-D convolutional layer applies sliding convolutional filters to the input data. It conducts convolution by sliding these filters along both the vertical and horizontal axes, computing the dot product between the weights and input, and then adding a bias term. The disclosed model incorporates two convolutional layers, each utilizing 3×3 filters. These filters are initialized with random values and function as learnable network parameters. For example, in FIG. 3, the conv2d layer comprises 2 filters, each sized 3×3 with padding, resulting in 2 output layers having the same height and width as the input layer. Similarly, the conv2d_1 layer includes 2 filters, each sized 3×3 with padding.

The Activation Layer: Non-linear activation functions, specifically the rectified linear unit (ReLU), are applied after the convolutional and dense layers (except the last dense layer). The ReLU layer performs a threshold operation on each element, setting any value less than zero to zero. This activation function introduces non-linearity into the network, enabling it to capture intricate patterns and enhance its classification performance.

The Max Pooling Layer: This layer conducts down-sampling by partitioning. Here, the input is divided into 2×2 size rectangular regions and the maximum number from each region is sampled.

The Flatten Layer: The spatial dimensions of the input are collapsed here, and it converts it into a one-dimensional vector. It transforms the input tensor having dimensions of (8, 8, 1) into a 64 size single-dimensional vector.

The Dense Layer: The dot product between the input and a weight matrix is computed in this layer. Following this, a bias vector is added to the result. Random values are used to initialize both the weight matrix and bias, and they serve as learnable parameters of the model. This layer is also known as the fully connected (FC) layer.

Loss Function and Optimizer: The last fully connected layer, dense_2, integrates the extracted features for image classification. Consequently, the last dense layer output size is set to one for binary classification. Then a score function, Sigmoid, is used. The agreement between predicted scores and the ground truth labels are quantified by the loss function. The job of the optimizer is to find the global minima by varying the network parameters. Global minima can be achieved when the loss function reaches its minimum value. In the proposed model, the binary_crossentropy loss is computed, and the RMSprop optimizer is utilized.

Training the Deep Learning Model: The dataset of 670,000 sound samples was converted to MFCC images, and it was then divided into three distinct subsets: 70% of images (i.e., 469,000) were allocated for training, 15% of images (i.e., 100,500) for validation, and 15% of images (i.e., 100,500) were reserved for testing. The latter set was withheld until after the model had undergone training and validation, allowing for a final assessment of model accuracy using previously unseen test samples. The mean and the standard deviation of the training dataset images are calculated and saved in the norm.npy file. Then, from all three data subsets, the mean was subtracted and then divided by the standard deviation to normalize the dataset.

The deep learning architecture, as illustrated in FIG. 3, was implemented using the Python programming language with the Keras library. Keras, a high-level neural networks application programming interface (API) built upon TensorFlow, was employed its versatility and user-friendly interface. Model training was carried out on a desktop computer featuring a 12th Gen Intel Core i7 processor (6 Cores) clocked at 2.10 GHz, 32 GB of RAM, and an NVIDIA GeForce RTX3070 graphics processing unit (GPU).

After training the CNN model, an H5 model is generated that can be used for inferencing. To reduce the inference time of the H5 model on the Jetson Nano, NVIDIA-TensorRT is used to convert the model to a TRT engine. TensorRT encompasses a deep learning inference optimizer and runtime, optimizing deep learning inference applications for minimal latency and enhanced throughput. It offers INT8 and FP16 optimizations, wherein reduced precision substantially diminishes inference latency.

Prototype System Architecture: The gunshot detection system architecture comprising the gunshot detector device, the central server for the emergency responder's station, and smartphone apps for users and emergency responders—as shown in FIG. 1—is designed and developed. The user places the device in a room and then uses the smartphone app to configure the Wi-Fi of the device, and also to update the user and the device information to the central server. Emergency responders use a smartphone app to update their information on the server. Once the configuration is performed, the user and the emergency responders are ready to receive smartphone notifications to any place in the world as long as there is Internet coverage. A concise overview of the various system modules is provided below.

Gunshot Detector Device: The gunshot detector device listens to the sounds in the environment and classifies it as gunshot or other. If a gunshot is detected—it sends data to the central server through the Internet using Transmission Control Protocol/Internet Protocol (TCP/IP) protocol and also saves the gunshot sound files in the device locally. The device is configured with the developed smartphone app. A brief description of the device's hardware and firmware follows.

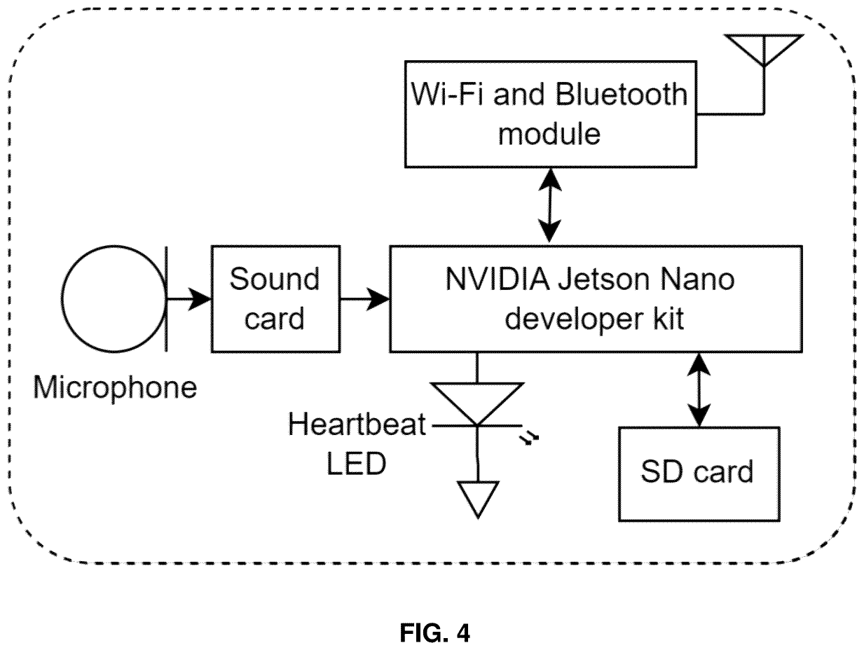

Hardware: The block diagram of the hardware unit of the gunshot detector device is shown in FIG. 4. The primary processing unit employed is the NVIDIA® Jetson Nano™ Developer Kit, a single-board computer known for its compact size and energy efficiency. This embedded platform excels in running neural network models effectively, such as image classification, object detection, segmentation, and more. The Jetson Nano™ Developer Kit is equipped with a powerful Quad-core ARM A57 microprocessor running at 1.43 GHz, and 4 GB of RAM. Additionally, it has a 128-core Maxwell graphics processing unit (GPU), a micro SD card slot, USB ports, general purpose input/output (GPIO), and various integrated hardware peripherals. An omnidirectional microphone with a built-in sound card is interfaced with the Jetson Nano using a USB. To connect with a smartphone using Bluetooth and to access the Internet wirelessly, a wireless Network Interface Card (NIC) supporting both Bluetooth and Wi-Fi is connected to the M.2 socket of the Jetson Nano. An LED to indicate the program is running—referred to as the heartbeat LED—is interfaced with a GPIO pin of the Jetson Nano. For the power supply, a 110 V AC to 5 V 4A DC adapter is used. To keep the microprocessor cool, a cooling fan is employed with pulse width modulation (PWM)-based speed control, positioned above the microprocessor.

Firmware: The Jetson Nano board is equipped with a 64 GB SD card, hosting Bionic Beaver, which is a specialized version of the Ubuntu 18.04 operating system. The application software is developed using the Python language, and all required packages, including JetPack 4.6.3, are installed on the system. Three Python programs—to configure Wi-Fi, detect gunshots, and access the recorded sounds—run in parallel in separate threads after the system boots. They are briefly described below.

Configure Wi-Fi: The purpose of this program is to configure the Wi-Fi connection of the device using the user's smartphone. After the booting, this program enables the Bluetooth advertisement of the Jetson Nano, so that the device is visible to the user's smartphone when scanning for nearby Bluetooth devices. Here, the Jetson Nano works as a Bluetooth server, and the smartphone as a Bluetooth client. The program then waits for a Bluetooth connection from the client using a socket. A timeout is used that will close the socket, disable Bluetooth advertising, and terminate the program if there is no connection request within 30 min after the boot. This shortening of the advertisement duration by timeout will prevent unwanted access to the device using Bluetooth. Once the smartphone connects with the device, the Bluetooth advertising is disabled and it waits to receive commands from the smartphone. The smartphone needs to know the Wi-Fi service set identifier (SSIDs) that are nearby to the device. When the smartphone sends a command to the device requesting the list of nearby SSIDs, the device generates the list using the nmcli tool for Linux devices and sends the list to the smartphone. In the smartphone, the user can choose the desired Wi-Fi SSID the device should connect and enter the password. The smartphone then sends a command, which includes the SSID and password, to the device requesting to connect. Once the device receives the command for Wi-Fi connection, the device tries to connect with the requested SSID and then replies with the connected SSID and its' local IP address. After the Wi-Fi configuration is performed, the smartphone sends a performed command, and the device then closes the socket connection, enables advertising, and waits for a new Bluetooth connection up to the timeout.

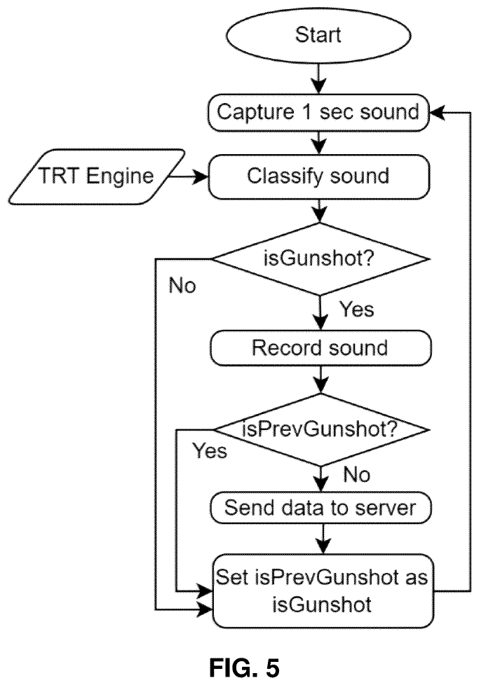

Detect Gunshot: A flowchart of the gunshot detection firmware is shown in FIG. 5. First, it captures a one-second sound having a sampling rate of 44,100 Hz. To classify the sound, it is normalized using the min-max normalization method and then the MFCC of the sound signal is calculated. Then, reading from the norm.npy file, the mean is subtracted and then divided by the standard deviation. The signal is then classified using the generated TRT engine, as described above, as gunshot or other. The engine outputs the gunshot probability of the captured sound, thus a probability greater than or equal to 0.5 is classified as gunshot sound. The flag isGunshot is set to True if the sound is classified as a gunshot, and False otherwise. The heartbeat LED is turned on at the beginning of the classification, and it is turned off after the classification.

If a gunshot is detected, then the sound is saved as a WAV file in the rec_gs folder in the SD card with the current date and time as the filename. As the device is connected to Wi-Fi, it can provide the correct date and time information. To avoid continuous notifications when several gunshots are fired one after the other within a short time, the program sends only one notification to the server for the first captured sound and does not send any notification for the successive gunshot sounds until a non-gunshot sound is captured. The last detected sound status is saved in the isPrevGunshot flag. If isGunshot is True and isPrevGunshot is False, then the program tries to connect with the central server with TCP/IP protocol using socket having a timeout of 5 s. In Python, a socket is similar to a communication endpoint that allows to send and receive data over a TCP/IP network, which is a set of rules for transmitting data between devices on the Internet or a local network. Once the IP address and port number of the target computer are specified, the socket can be used to establish a connection and exchange data. After connecting with the server, the device sends a data string containing the serial number of the device and the current date and time. The program reads the Bluetooth's media access control (MAC) address of the Jetson Nano and it is used as the serial number of the device. Then, isPrevGunshot flag is updated with the isGunshot flag value and the process repeats.

Server for Accessing Recorded Sounds: To access and play the recorded gunshot sounds for post-crime analysis, a Hypertext Transfer Protocol (HTTP) server runs in the device at port 8000 having the working directory as the rec_gs folder, where the gunshot sounds are saved. Thus, these files can be accessed and played by the user's smartphone using the local Internet Protocol (IP) of the device and the port number as long as the smartphone and the device are connected to the same Wi-Fi network. The smartphone obtains the local IP of the device when its Wi-Fi is configured.

Central Server Software: The central server, developed with Visual C# and Microsoft SQL Server, contains functionalities for plotting the gunshot event on the map, generating alerts, sending push notifications to smartphones, and querying the database using a graphical user interface (GUI). This server can be hosted on a computer in any institution, such as a school or office, where emergency responders can monitor the events.

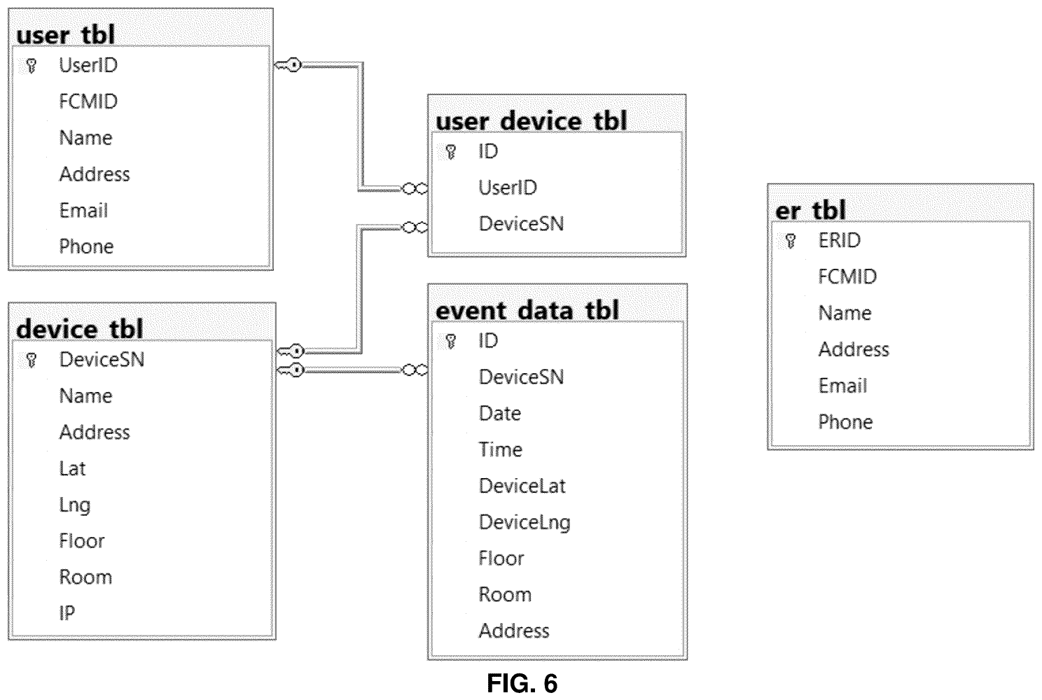

SQL Database: The software implements an SQL database. The database tables, their fields, and their relationships are shown in FIG. 6. In FIG. 6, the primary key of each table is marked using a key sign on the left side of the field name; and the lines indicate relationships between a primary key field at the left and a foreign key field at the right.

The user_tbl table contains the customer or the user information such as name, address, email, and phone. The user's smartphone's Android ID is used as the unique UserID. One user can have several smartphones and each smartphone app is treated as a separate user. To send notifications to the user's smartphone in the event of a gunshot, the Firebase Cloud Messaging (FCM) registration token is stored in this table in the FCMID field. A unique Android ID and a unique FCM registration token are generated for each user when the person installs the smartphone app. The device_tbl table contains the device information. As discussed above, in Firmware the Bluetooth MAC address is used as the unique device serial number and it is stored in the DeviceSN field. The location information of the device such as latitude and longitude, address, floor, and room are stored in this table so that emergency responders can quickly go to the place where the gunshot is detected. Users can assign a nickname to the device and it is stored in the Name field. The local IP of the device is stored in the IP field. The user_device_tbl connects the users and the devices. One user can have multiple devices installed, such as in several rooms in a building. One device can have multiple users, such as each family member in a home. Thus, there could be a many-to-many relationship between users and devices. Each row of this table connects a user with a device using the UserID and DeviceSN namely. The ID field of this table is an autoincrement primary key field. The er_tbl table contains a list of emergency responder's information such as ERID, FCMID, name, address, email, and phone. Similar to the user table, ERID stores the Android ID, and the FCMID stores the FCM registration token. The event_data_tbl table contains information on each gunshot event such as the serial number of the device where the gunshot is detected, date, time, and location information of the device. This table keeps track of all the gunshot events and can be used for querying data.

Data Processing in TCP Server: The central server implements a Transmission Control Protocol (TCP) server and listens at port 8050. Connecting the gunshot detector devices or smartphones to this server necessitates a stable public IP address and an accessible port. The router's public IP, provided by the Internet service provider (ISP), typically remains constant and serves as the fixed public IP. To facilitate the transmission of incoming data packets from the Internet to the custom TCP server port, a static local IP is set for the server computer and configure port forwarding on the router. Additionally, the port number is opened in the Firewall settings. The TCP server receives user and device configuration data, emergency responder configuration data from smartphones; and gunshot notification data from gunshot detector devices. The first byte of the data indicates whether it is user and device configuration data, emergency responder configuration data, or gunshot notification data. The handling of these three kinds of data is briefly described below.

User and device configuration data: The user and device configuration data string contains: each field value of the user_tbl; the total number of devices; and each field value of the device_tbl for each device. Each field value is separated by a vertical line character, I, instead of a comma because a comma could be part of the ‘address’ field of a user. When the data arrive at the server: the data are parsed, saved in variables, and stored in the database tables. If the UserID already exists in the user_tbl, then that user information is edited by updating the row with the data; otherwise, a new user is added by inserting a new row in the table. SQL queries are executed from the software by connecting to the database to accomplish these tasks. Then, for each device listed in the data, the DeviceID is checked in the device_tbl. If the DeviceID already exists in the device_tbl, then the device information is updated with the data; otherwise new device data are added to the table. After that, the user_device_tbl is updated to assign the devices to the user. First, all the rows containing the UserID of the user are deleted. Then, for each device listed in the data, the UserID and the DeviceSN are inserted as rows in the table. In this way, the assignment of devices with the user is maintained whenever the user adds, edits, or removes a device.

Emergency responder configuration data: This data string contains each field value of the er_tbl. Once the data arrive at the server: the data are parsed, saved in variables, and stored in the database table. The emergency responder's information is updated if the ERID already exists in the er_tbl, and a new emergency responder is added if the ERID does not exist in that table.

Gunshot notification data: These data arrive at the server from the gunshot detector device when a gunshot event is detected. It contains the DeviceSN, and the event date and time. After the data arrive at the server: the location information of the device is queried from the device_tbl using the DeviceSN; a new row is inserted in the event_data_tbl to save the event information in the database; plotted on the map with a marker; gunshot detection message is displayed; a warning sound is generated; FCM push notifications are sent to the smartphones of the users of that device and all the emergency responders. To send the push notifications to each user assigned to the device: the FCM registration tokens for each user of the device are gathered from the user_device_tbl and user_tbl using a multiple table query. Each push notification contains the DeviceSN, the location information of the device, and the event date and time.

Searching Gunshot Events: The software implements a GUI where the user can choose a range of dates and times, a rectangular area on the map, or both, to search for gunshot events. An SQL query is made based on the chosen criteria and the result data are retrieved from the database. Then, the gunshot events from the result data are plotted on the map and the associated location and user information are displayed.

Smartphone App: Two smartphone apps are developed for the Android platform: for users and emergency responders. These apps contain a settings window where the user's or emergency responder's information, as shown in user_tbl and er_tbl namely in FIG. 6, can be entered. The UserID and the ERID, which are the unique Android IDs of the smartphones, and the FCMID, which is the FCM registration token, are assigned automatically without manual input.

The main difference between these two apps is that the user app contains options for configuring their devices, whereas the emergency responder app does not contain options for device configuration as they are not users of any device. The setting window contains a custom list view that shows the list of devices the user has. New devices can be added and existing devices can be edited or removed from here. The properties of these devices, as shown in device_tbl in FIG. 6, can be updated by selecting the device. To make the device location input process easier: the smartphone can be placed near the device, and the GPS location and address information can be retrieved automatically using the GeoLocation library. The Wi-Fi configuration of the device, as discussed above in Firmware, is implemented with GUI in the app. It contains a window where nearby Bluetooth devices can be searched and connections can be made. The device must be paired with the smartphone before connection. After connecting: the Bluetooth MAC address is assigned as the DeviceSN, the list of available Wi-Fi SSIDs is retrieved from the device and shown in the app, and the user can choose the desired SSID and provide a password—as discussed in herein in Firmware. When the app leaves the setting window: the smartphone connects with the central server using the Internet as a client and sends the configuration data using a socket that updates the database in the server.

Once the Wi-Fi of the device is configured, the smartphone app obtains the local IP of the device. Using the local IP and the HTTP server port of the device, the gunshot sounds recorded in the device can be accessed and played from the smartphone.

The first screen of these apps contains a list of gunshot events showing the device name and serial number; its location; and the date and time of the event. These apps are registered in the FCM dashboard for receiving push notifications. In this application, there is a background service called FirebaseMessaging. When this service receives a push notification message from Firebase Cloud Messaging (FCM), it triggers a callback function. Subsequently, the app performs several actions, including adding the received message to a list, saving the list to a file, generating a smartphone notification, and updating the list view on the screen. If the user clicks on any item in the list view, the application opens Google Maps, setting the destination to the gunshot detector device's current location. This feature enables the user or an emergency responder to navigate to the site promptly.

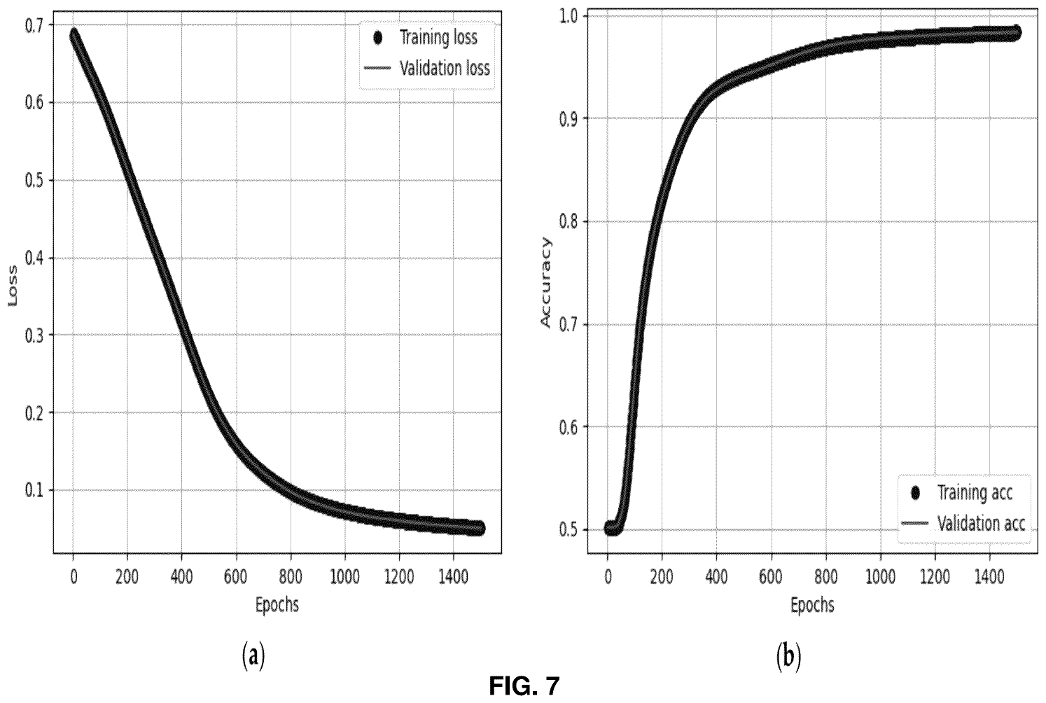

Gunshot Detection Deep Learning Model Results: The CNN model, as discussed above, is trained and validated simultaneously until the validation loss is smaller than or equal to 0.05, or for 5000 epochs-whichever is reached first. The training and validation batch size is set to 2048. The learning rate and the learning rate decay are set to 1×10⁻⁶ and 1×10⁻⁷, respectively. Graphs illustrating the trends of loss vs. epochs and accuracy vs. epochs for both the training and validation datasets are presented in FIG. 7, which depict a consistent decline in loss and a corresponding increase in accuracy as the number of epochs progresses. Upon reaching the 1501 epoch mark, the model achieved a validation loss of 0.05 and stopped after 1 h 4 min, and 22 s of training. Remarkably, both the training and validation datasets demonstrated an accuracy of approximately 0.98 after the 1501 epoch training phase.

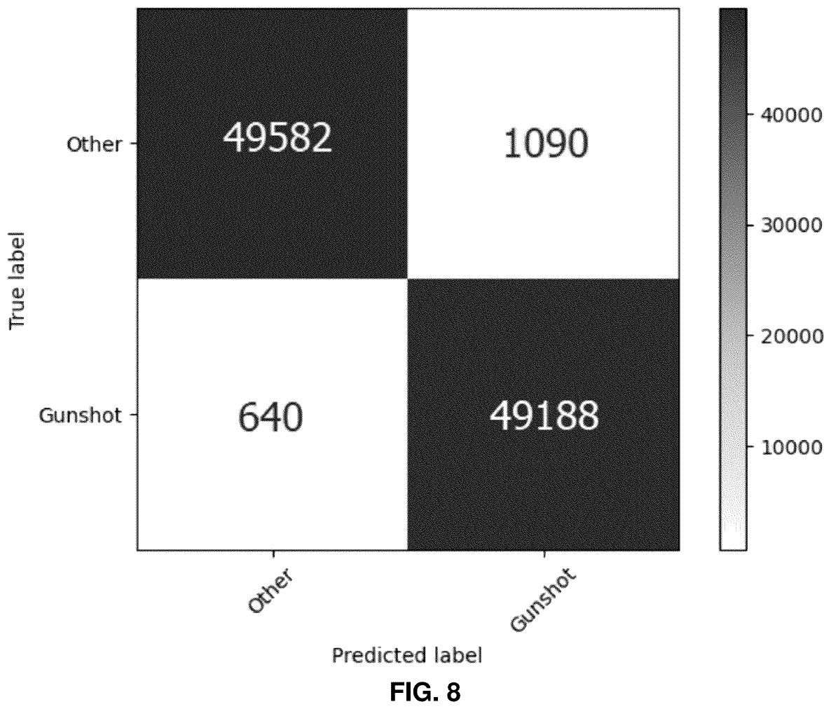

After completing the training and validation phases, the model, comprising a total of 1224 learned parameters (including filters, weights, and biases), was saved in an H5 file. The model's disk size amounted to 62.66 kB. Subsequently, the model underwent testing using an unseen test set containing 100,500 samples. During this testing phase, the model achieved a loss of 0.0505 and an accuracy of 0.98. Table 2 provides an overview of the loss and accuracy values for the training, validation, and test datasets, highlighting that the model exhibits similar accuracy across all sets, indicating its robust generalization. FIG. 8 illustrates the confusion matrix for the test dataset, while Table 3 presents the precision, recall, and f1-scores for the test dataset. The disclosed deep learning model achieves an accuracy of 98% and 2% of the data are misclassified. The reason for this 2% misclassification could be that some sounds might be affected by variations in recording conditions, or different speakers, making it challenging for the model to generalize across diverse inputs. The choice of hyperparameters and architecture might not be perfectly suited for some ambiguous sounds, potentially leading to misclassification. The inherent ambiguity in certain sound patterns or overlapping acoustic features can pose difficulties for any model, limiting its accuracy to less than 100%. Thus, achieving 100% accuracy with CNNs is difficult for a large dataset due to these inherent challenges in the data and modelling.

TABLE 2
The loss and accuracy of the training, validation, and test datasets.

| | Training | Validation | Test |
|---|---|---|---|
| Loss | 0.0504 | 0.0500 | 0.0505 |
| Accuracy | 0.9831 | 0.9832 | 0.9828 |

TABLE 3
The precision, recall, and f1-scores of the test dataset

| | Precision | Recall | f1-Score |
|---|---|---|---|
| Gunshot | 0.98 | 0.99 | 0.98 |
| Other | 0.99 | 0.98 | 0.98 |

Prototype System Results: A prototype of the disclosed system comprising the gunshot detector device, the central server for the emergency responder's station, and smartphone apps has been developed and tested successfully. The device is enclosed in casing, having a dimension of approximately 15.5×12.3×4 cm. The device is programmed as described above and is configured to run the programs automatically on boot. On the Jetson Nano device, the average pre-processing time of one recorded sound which includes MFCC generation and normalization is 29 ms, and the inference time by the deep learning H5 model is 212 ms. However, after converting the H5 model to the TRT engine, as described above, the inference time by the TRT engine is reduced to only 3.9 ms, making the inferencing 54 times faster. The power consumption of different parts and the entire device is measured using the jetson-stats library and shown in Table 4.

TABLE 4
Power consumption of the gunshot detector device

| Hardware Part | Power | |
|---|---|---|
| Jetson Nano's CPU | 854 | mW |
| Jetson Nano's GPU | 40 | mW |
| Entire Device | 2.7 | W |

After the device is powered up, the heartbeat LED starts to blink indicating the program is running and listening for sounds. The central server was running on an Internet-connected computer. The system is then configured using the smartphone app. Using the app, a user and a device are added, and the Wi-Fi of the device is configured successfully. In the central server, the user and device information got updated as expected. Using the smartphone app designed for emergency responders, an emergency responder was also added to the system.

The gunshot detector system was tested inside a lab environment, by playing recorded sounds near the device rather, than performing actual shootings to avoid the destruction of properties. During testing, different sounds other than gunshots were played and they were successfully detected as others. Then, gunshot sounds were played, sometimes mixing with other environmental noise and background sounds, and the device successfully detected the sound as a gunshot and notified the central server within a second. Upon receiving the notification data from the device, the central server: successfully marked the location of the gunshot event on the map, displayed the assigned user and device information in the event log, saved the event data in the database, generated warning sounds, and sent smartphone notifications to the assigned user and all the emergency responders. The system was also tested with multiple emergency responders, multiple users, and devices with many-to-many relationships, and notifications were sent successfully as expected.

In the central server, gunshot events can be successfully searched using a range of dates and times, a rectangular area on the map, or both.

Summary: The disclosed gunshot detection system is targeted for indoor use such as inside schools, grocery stores, and offices. Thus, possible false alarm sounds from outside, such as fireworks, may have less effect on this system. The other (i.e., the non-gunshot) dataset class contains possible false alarm sounds for gunshots such as fireworks, can opening, door knock, glass breaking, clapping, drum, and thunderstorms. Thus, the deep learning model is already trained to classify these sounds as other sounds. To further protect the system from false alarms generated by fireworks, the probability threshold level of the classifier can be automatically increased when fireworks generally happen—for instance, on 4 July and the night of 31 December in the USA.

The disclosed gunshot detection system can also be used in homes. However, the gunshot sounds generated by the people in the home from mobile, computer games, or movies can produce false alarms. To solve this problem, an app can be developed that will be installed on those mobiles and computers. The app will run in the background, read the sounds generated by the mobile or the computer, classify it as gunshot or other according to the proposed deep learning model, and then notify the gunshot detector device using Wi-Fi if a gunshot sound is detected in the mobile or in the computer. If the gunshot detector device detects a gunshot sound through its microphone and it also receives such notification from this app, it will then recognize the gunshot as a false alarm.

A mischievous act could be that someone intentionally plays a gunshot sound using a mobile device near the detector to create a false alarm. This mischievous act can be encountered by interfacing an infrared sensor with the gunshot detector device. Infrared radiation, which includes wavelengths beyond the visible spectrum, is emitted when a gunshot is fired. This phenomenon is primarily associated with the intense heat generated during the firing process. When a firearm is discharged, the rapid combustion of gunpowder within the cartridge produces extremely high temperatures. This intense heat causes the surrounding air and the firearm's components, including the barrel, to heat up significantly. As a result, these hot objects emit infrared radiation, which can be detected by infrared sensors. Thus, if the gunshot detector device detects only sound without any significant increase in infrared radiation near it, then it will be considered a false alarm. A sensor fusion approach can be implemented by interfacing an infrared sensor with the device. To further increase accuracy and lower false alarms, object detection (such as guns and people) from camera images can be implemented. Moreover, the proposed sound classification method can be used to detect situations such as crying, glass breaking, and drone arrivals.

Data transmission from the device to the central server using sockets may introduce security vulnerabilities. The issue of handling security is planned to be implemented in future work. The detected gunshot sounds, saved as WAV files inside the device, are not transmitted to the central server. These files can only be accessed by the user's smartphone when he/she is on the same Wi-Fi network as the device. Thus, there is no privacy concern.

Due to safety reasons, the disclosed gunshot detection system was tested by playing recorded gunshot sounds instead of actual shooting with firearms. The system can be tested with actual guns inside a shooting range. Moreover, if a silencer is used on a gun, then the generated sound will be different than the traditional gunshot sound. To detect these types of gunshot sounds: samples of gunshot sounds with silencers can be collected, added to the gunshot class dataset, and then used to retrain the model. A new gunshot sound dataset recorded inside a shooting range can be made with the same microphone used in the device. After training the model with this dataset, the system will be tested with actual shooting with different types of firearms—with and without silencers—inside a shooting range. The system can be tested in the shooting range with different distances and measure its performance considering environmental noise in the future.

If there are multiple gunshot detector devices, such as in different classrooms of a school, and a gunshot is detected by more than one device, then the central server can prioritize the location of the device that detected the largest sound volume. The device can measure the maximum volume of the sound and send it to the server when a gunshot is detected.

The proposed device needs a Wi-Fi connection to send data to the central server when a gunshot is detected. As Wi-Fi is generally available indoors, the device will work indoors only and will not work outdoors. However, the device can be used outdoors by interfacing with a cellular modem, which will give Internet access to the device outdoors. In the outdoors, the power supply might be a challenge.

### Example 2

This example illustrates an indoor gunshot detection method and notification system using deep learning according to the disclosure, which further incorporates enhanced security features and testing using blank guns. The generation of the custom dataset, time and frequency domain feature extraction, the deep learning model architecture, and the training of the model are discussed below.

Compared to previous works summarized in Table 1A, this example involves recording a new custom dataset of blank gunshot sounds and training a deep learning model, using both time domain and frequency domain features, to differentiate between gunshot and non-gunshot sounds. The gunshot detection system is implemented consisting of servers, a detector device on a Raspberry Pi Zero 2W embedded system, and a smartphone app. The system is tested with blank gunshot sounds in real-time and also tested with potential false alarms such as fireworks, action movies, and balloon burst sounds. To improve security and privacy issues related to the embodiment illustrated in Example 1, this example integrates secure MQTT communication protocols, improved authentication mechanisms, Wi-Fi provisioning without requiring Bluetooth, and over-the-air (OTA) firmware updates.

Custom Dataset Generation: To classify gunshot sounds from other sounds, two classes in the dataset are required: gunshot sound and non-gunshot (or others) sound.

Gunshot sound: In Example 1, gunshot and non-gunshot sounds were downloaded from online datasets such as BGG, Free Firearm Sound Effects Library, Urbansound8k, etc. These sounds were recorded with different types of microphones, which are different from the microphone used in the gunshot detector prototype. The amplitudes of some of these sounds were normalized and they lost the loudness or volume information compared to background sounds. A new custom dataset is used in this example to improve performance.

A custom recording device is designed and developed for this example. A miniature MEMS microphone is interfaced with a Teensy 4.1 Development Board using I2S protocol. The Teensy board contains an ARM Cortex-M7 processor running at 600 MHz, 7936K Flash, 1024K RAM, 2 I2S digital audio ports, USB, and other ports. Its USB port can operate in device or peripheral mode at 480 Mbit/s speed. The software enables bidirectional stereo audio streaming, and the board is recognized by the computer as a USB sound card. Using the Audio System Design Tool for Teensy Audio Library, firmware for the Teensy was generated to send I2S data from the microphone to the USB of the computer. The NCH WavePad version 17.44 audio processing software was used in the computer for recording. Recordings were done at a 44.1 kHz sampling rate having a resolution of 32 bits in the mono channel mode.

In this example, the developed gunshot detector is trained and tested with blank gun sounds. Blanks or starter pistols generate exact gunshot sounds but do not throw any bullet. These guns are used for active shooter training and Hollywood movies. Thus, the gunshot sounds can be recorded and the detector can be tested safely in an indoor environment with blank guns. A Zoraki M906 blank gun was used to develop the dataset. The recordings were done in four different university building locations: research lab, breakroom, building corridor, and faculty office hallway. Three recording devices with laptops were placed at different places in each location. On each of the 4 locations, 25 shots were fired from random spots. In this way, 3×4×25=300 gunshot sounds were recorded. Each of the gunshot sounds was then split into 1-s WAV files manually.

Data augmentation is a technique used to generate new training examples by making slight modifications to the existing data. This process enhances the model's ability to learn by providing it with more diverse examples, helping to improve its overall performance and robustness. Using NCH WavePad software, the following effects were added to augment the sound data: time shifting (this technique involves shifting the audio waveform in time, either forward or backward, without altering its content or duration); location effects such as auditorium, bathroom, and hanger; echo with different delays; different levels of phaser, equalizer, flanger, tremolo, vibrato, distortion, and chorus; and reverb for different types of building materials. More samples were created by overlaying non-gunshot sounds, as described below, with the gunshot sounds as gunshots may happen with the presence of background noise. After applying the data augmentations, a total of 77,667 WAV files were generated.

Other sounds: A custom dataset of non-gunshot sounds, defined as “other” sounds, was generated using the developed recording device. For this example, this dataset should contain the possible non-gunshot sounds that might be available in indoor environments such as in schools, offices, grocery stores, etc. Several crowd noises were recorded in the cafeteria, classrooms, and hallways. Moreover, a recording was done inside a lab where a group of volunteers sat together and made random sounds such as talking, laughing, clapping, screaming, playing ringtones, music, game sounds from smartphones, dropping objects, etc. Along with recorded sounds, some audio was downloaded from online sources such as 20-20,000 Hz audio sweep, a school bell tone, announcement, balloon pop, basketball bouncing, coffee shop ambiance, fire siren, footsteps, highway sounds, TV ambiance, rain, thunderstorm, party noise, power tools, vacuum, classroom music, radio ambiance, school cafeteria ambiance, school hallway ambiance between classes, sliding door opening and closing, smoke alarm, video game, whistles and horns, noisy classroom, kids screaming, etc. The amplitude of these downloaded sounds was reduced using WavePad software so that it approximately matches the amplitude levels of the custom recording device. All these sounds were split into 1 s WAV files and a total of 94,211 other or non-gunshot sound files were generated.

Time and Frequency Domain Feature Extraction: In Example 1, only frequency domain features were used. However, the loudness of the gunshot sound can also be considered along with its frequency during classification, to reduce false alarms when tested with low volume sound of gunshots that may come from TV or gaming devices. In this example, both time domain and frequency domain features are used as inputs to the classifier.

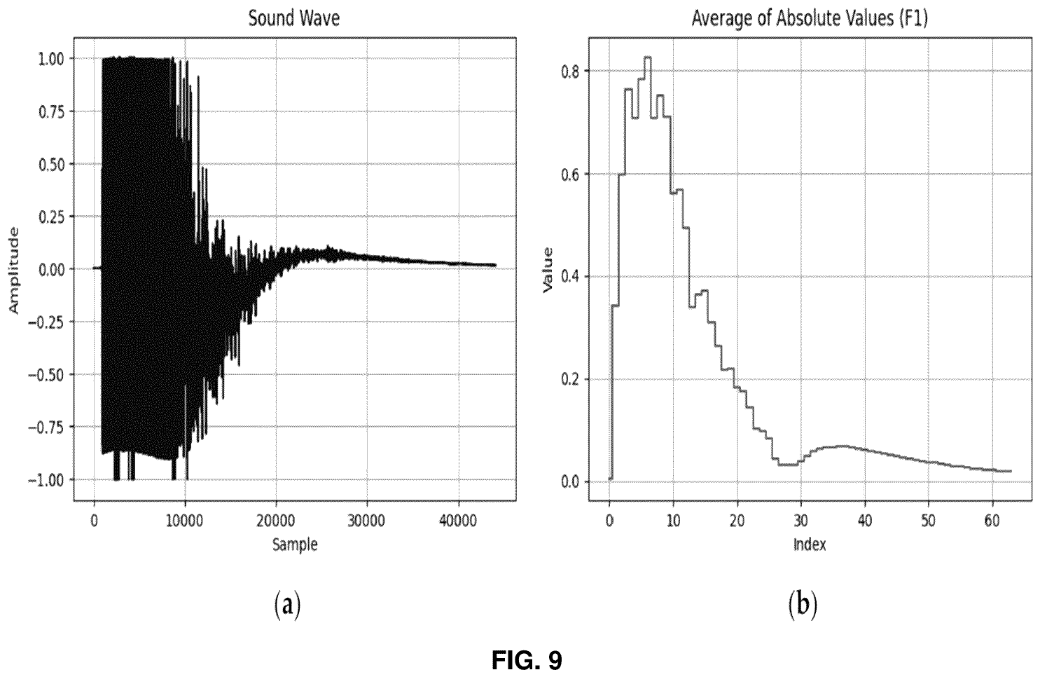

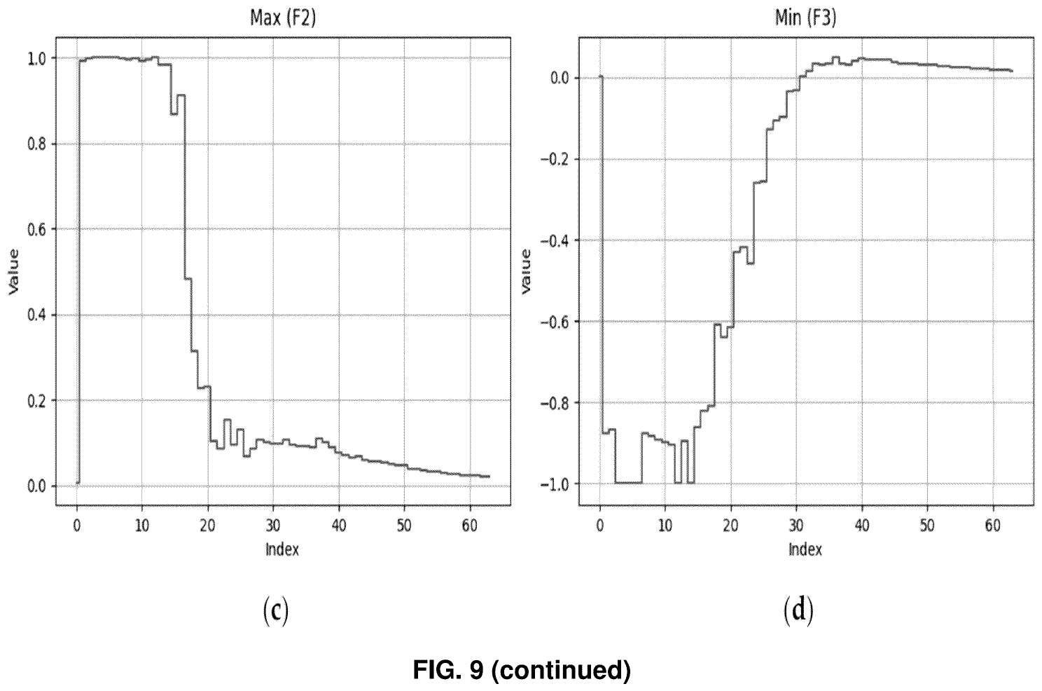

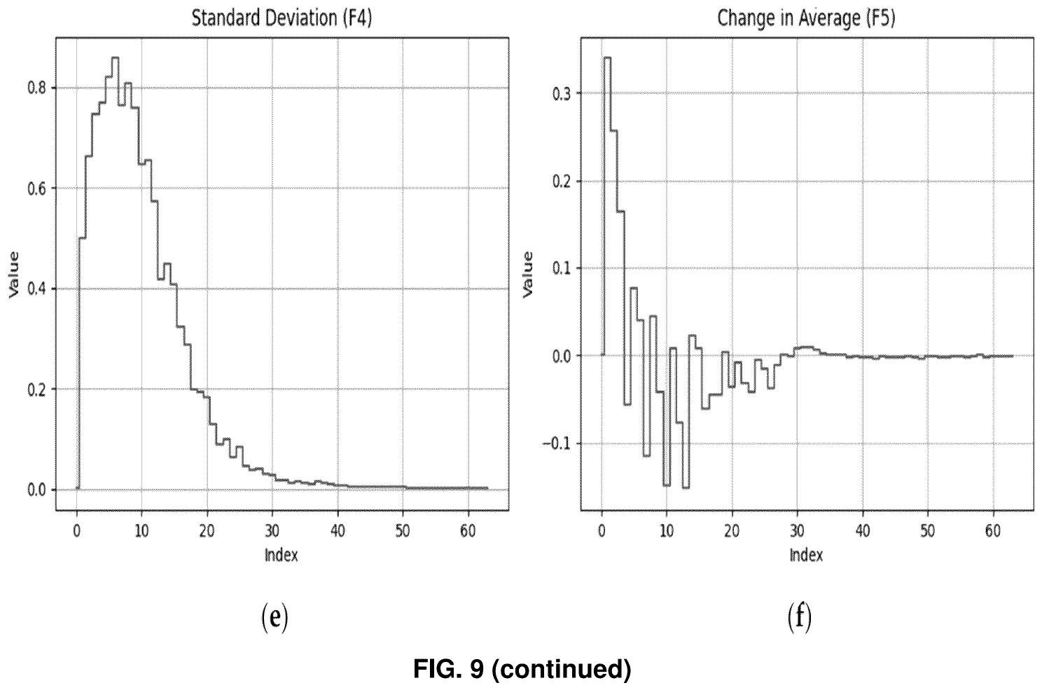

Time Domain Features: The DC value from the one-second sound is first removed by subtracting its average from each sample. Each sample is also divided by the maximum 32-bit integer (i.e., 2³¹−1) to normalize the samples so that the values range from −1 to 1. For each one-second sound, a feature vector of length 64 is generated for each time-domain feature. Among the 44,100 samples of the one-second sound, the first 44,096 samples were equally sliced to 64 windows, each window having N=689 samples. For each of these 64 windows, 5 time-domain features: the average of absolute values (F1), maximum (F2), minimum (F3), standard deviation (F4), and differences between consecutive elements of the average vector (F5) are calculated. Let xi[j] represent the jth sample in the ith window, where i∈{1, 2 . . . , 64} and j∈{1, 2 . . . , 689}. For each window i, the features are computed using (1)-(5). In (5), F5ᵢ is set to 0. FIG. 9 includes (a) a time domain plot of a gunshot sound, and (b)-(e) the five calculated time domain features according to equations (1)-(5).

$$F {1}_{i} = \frac{1}{N} {\sum }_{j = 1}^{N} \vert {x}_{i} [ j ] \vert \qquad ( 1 )$$

$$F {2}_{i} = {max}_{j ∈ \{ 1 , 2 , … , N \}} {x}_{i} [ j ] \qquad ( 2 )$$

$$F {3}_{i} = {min}_{j ∈ \{ 1 , 2 , … , N \}} {x}_{i} [ j ] \qquad ( 3 )$$

$$F {4}_{i} = \sqrt{\frac{1}{N} {\sum }_{j = 1}^{N} {( {x}_{i} [ j ] - {μ}_{i} )}^{2}} , where {μ}_{i} = \frac{1}{N} {\sum }_{j = 1}^{N} {x}_{i} [ j ] \qquad ( 4 )$$

$$F {5}_{i} = F {1}_{i} - F {1}_{i - 1} when i > 1 \qquad ( 5 )$$

Frequency Domain Features: To extract frequency domain features, the DC value from the one-second sound is first removed by subtracting its average from each sample. Then Mel Frequency Cepstral Coefficients (MFCCs) are generated by transforming the time-domain audio signal. The core idea behind MFCCs is to compress essential audio information into a compact set of coefficients, modeled after the auditory perception of the human ear. To calculate the MFCCs, the audio signal is first divided into windows of 20-40 milliseconds each. For every window, the power spectrum is computed by applying the Fast Fourier Transform (FFT). Then, triangular Mel filter banks are generated and applied to the power spectrum, resulting in a spectrogram. Since the human ear is more sensitive to small pitch variations at lower frequencies (below 1 kHz) than at higher ones, the first ten filters in the Mel filter bank are linearly spaced at frequencies of 100, 200, . . . , and up to 1000 Hz. Above 1 kHz, the filters follow the logarithmic Mel scale. After applying the filters, the logarithms of the filter bank energies are taken, and a discrete cosine transform (DCT) is applied to decorrelate the filter bank coefficients. The first DCT coefficient contains the average (or DC) value of the signal and it is not needed for classification. So, it is replaced with log energies of the signal. This process effectively captures the key characteristics of the sound, making it well suited for sound classification tasks.

In this example, the one-second sound is segmented into windows of 1024 samples (i.e., 23 milliseconds) each. Overlapping windows are implemented by calculating the stride (i.e., the offset for the next window in terms of samples) using (6) and (7) so that the total number of windows for the one-second sound matches with the feature length of the time domain features. To get TOTAL_WINDOW as 64, the OVERLAP_PERCENTAGE is set to 34, WINDOW as 1024, TOTAL_SAMPLES as 44,100, and STRIDE is calculated to be 676.

$$STRIDE = round ( WINDOW \times ( 1 - \frac{OVERLAP\_PERCENTAGE}{100} ) ) \qquad ( 6 )$$

$$TOTAL\_WINDOW = ⌊ \frac{TOTAL\_SAMPLES - WINDOW}{STRIDE} ⌋ + 1 \qquad ( 7 )$$

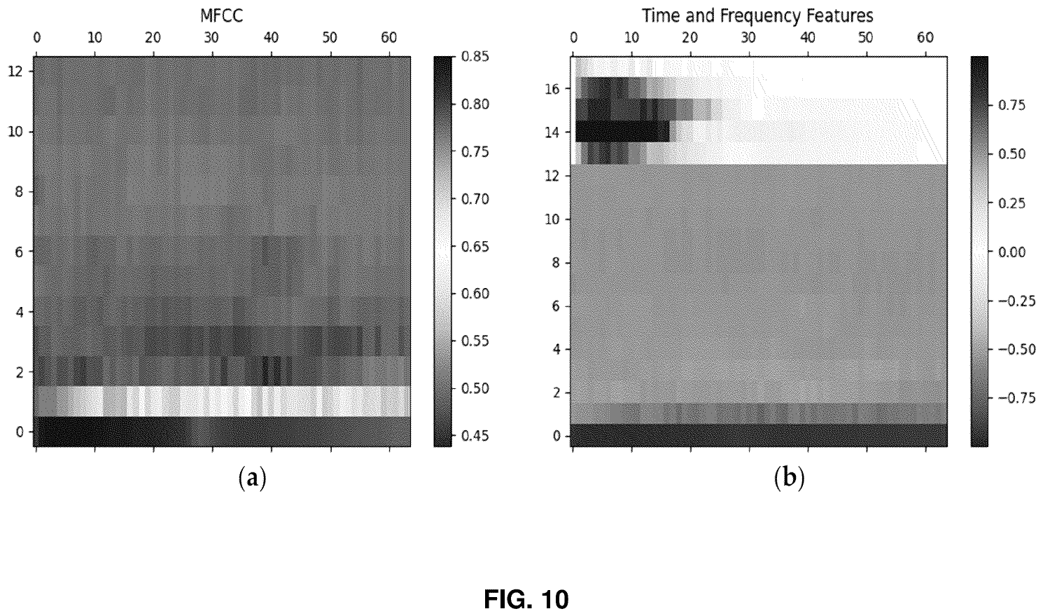

A filter bank with 15 filters is applied, the FFT is computed with 1024 points, and the number of DCT coefficients is set to 13. This results in an MFCC representation consisting of 13 cepstral coefficients for each window. Then, the coefficients are normalized using max-min normalization. Here, the max and min values were set as constants of 50 and −50, respectively. They were calculated by finding the max and min of the MFCC coefficient values for the entire dataset. In FIG. 10 (panel (a)), the MFCC coefficients are shown for the gunshot sound shown in FIG. 9 (panel (a)).

The time domain features and the frequency domain features are then stacked together and a 2D feature vector of 18×64 is generated as shown in FIG. 10 (panel (b)) in which the rows from 0 to 12 are the frequency domain features and the rows from 13 to 17 are the five time domain features. After this transformation, the one-dimensional time-domain sound signal is converted into a two-dimensional matrix, similar to an image. By utilizing this image representation, image classification deep learning models, such as Convolutional Neural Networks (CNNs), can be applied for classification. A dataset of a total of 155,000 images is generated from the two classes of sound samples and used as input for the deep learning model during classification. The MFCC data and their corresponding class labels are randomly shuffled while maintaining the correct pairing between data and labels.

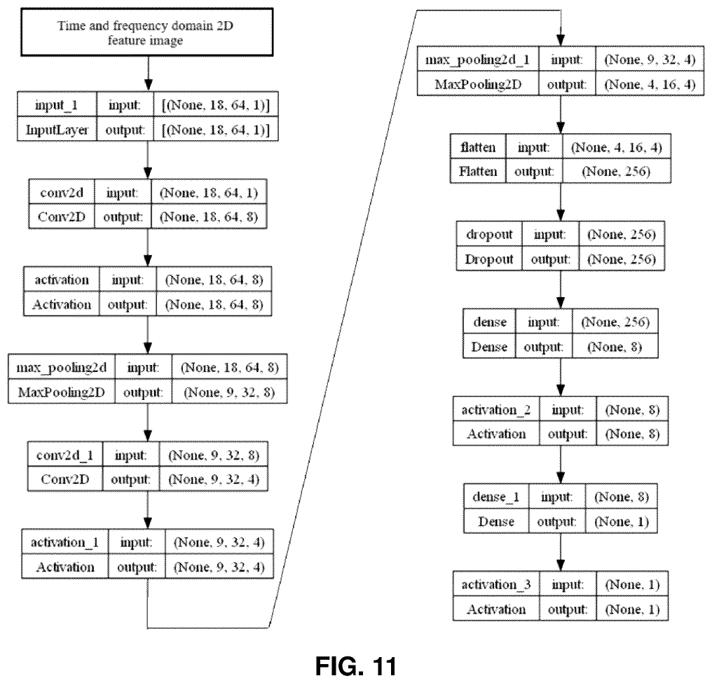

Architecture of the Deep Learning Model: Multiple attempts were made to create a model that effectively fits the dataset while maintaining adequate capacity (i.e., parameters) to avoid overfitting. Initially, a model with a high number of parameters was used, and the batch size was progressively increased until memory constraints became a factor. Afterward, the model's capacity was gradually reduced to achieve the right trade-off between accuracy and capacity. Learning rate adjustments and decay settings were fine-tuned whenever the validation loss was not decreasing for long training periods. Ultimately, the final deep learning model, as shown in FIG. 11, was designed to classify sounds as either gunshots or non-gunshots. The model's architecture and its optimizer are summarized below.

Input Feature: In this example, the one-dimensional time-domain audio signals are converted to two-dimensional 18×64 image-like representations. They serve as the input to the deep learning classifier.

Convolutional and Activation Layers: The model consists of two convolutional layers followed by ReLU activation functions. The first convolutional layer uses 8 filters of size 3×3 with “same” padding, ensuring the output retains the input's spatial dimensions. The second convolutional layer uses 4 filters of size 2×2, also with “same” padding. Both layers are responsible for learning hierarchical spatial features from the input images, while the ReLU activations introduce nonlinearity by setting any negative values to zero, allowing the network to capture more complex patterns in the data.

Max Pooling Layers: After each convolutional layer, a 2×2 max-pooling layer is applied to down-sample the feature maps. The first max-pooling layer reduces the dimensions of the feature map from (18, 64, 8) to (9, 32, 8), while the second maxpooling layer further reduces it from (9, 32, 4) to (4, 16, 4). These layers help reduce the computational complexity of the model and retain the most relevant information by selecting the maximum value in each pooling window.

Flatten and Dropout Layers: The 3D feature maps produced by the final max-pooling layer are flattened into a one-dimensional vector of size 256, allowing the data to be passed into fully connected layers. To prevent overfitting, a dropout layer with a rate of 0.2 is applied, randomly setting 20% of the neurons to zero during each training iteration. This encourages the model to generalize better by not relying on specific neurons.

Fully Connected (Dense) Layers: The flattened vector is passed through a dense (fully connected) layer with 8 neurons, followed by a ReLU activation function. This layer learns the complex relationships between the features extracted by the convolutional layers. The final dense layer contains 1 neuron, which outputs a single value for binary classification.

Output Layer: A Sigmoid activation function is applied to the output of the final dense layer, producing a probability between 0 and 1. This allows the model to classify the input as either a gunshot or non-gunshot sound based on the computed probability.

Loss Function and Optimizer: The model is compiled using the binary_crossentropy loss function, which measures the difference between predicted probabilities and the true labels (gunshot vs. non-gunshot). The RMSprop optimizer is used with a specific learning rate and decay schedule to ensure efficient training.

Training the Deep Learning Model: From the gunshot and other class sound samples, 77,500 samples are randomly selected from each class and converted to 155,000 feature images. The images are then split into three distinct subsets: 70% of the images (108,500) were designated for training, 15% (23,250) were set aside for validation, and the remaining 15% (23,250) were reserved for testing. The test set was kept isolated until the model completed training and validation, allowing for an unbiased evaluation of model performance on unseen data.

The deep learning model, as shown in FIG. 11, was implemented using Python and the Keras library. Keras, which serves as a high-level API for building neural networks on top of TensorFlow, was chosen for its flexibility and ease of use. The model was trained on a desktop computer equipped with a 12th Gen Intel Core i7 processor (6 cores) running at 2.10 GHz, 32 GB of RAM, and an NVIDIA GeForce RTX3070 GPU. After training, the model was converted from a TensorFlow model to a LiteRT model, so that it can be used for inferencing in a low-resource embedded system.

Prototype Development with Security: The architecture of the gunshot detection system consists of the central server, gunshot detector devices, and smartphone app, as illustrated in FIG. 1. Users attach the device to the walls or ceilings and configure its Wi-Fi settings through the smartphone app. Once the setup is complete, users can receive smartphone notifications from anywhere in the world, provided they have Internet access. The user and device data configuration using the smartphone and database schema of the proposed system was discussed in Example 1. In this example, the focus is concentrated on some security issues such as MQTT communication protocol with improved authentication mechanisms, Wi-Fi provisioning without requiring Bluetooth, and over-the-air (OTA) firmware updates. A brief overview of the system's key modules is presented below.

Server Software: In the central server, three server software runs MQTT broker, OTA server, and MySQL database server. The database is described in Example 1. The MQTT broker and the OTA server are discussed below.

Message Queuing Telemetry Transport (MQTT) Broker: In Example 1, there was no authentication to connect to the Transmission Control Protocol (TCP) server and it was open to cyber-attack. To solve this, a secure MQTT transmission protocol, designed for Internet of Things (IoT) applications, is used to communicate bidirectional data among the gunshot detector devices, the central server, and smart-phone apps. The MQTT protocol offers an efficient and lightweight approach to messaging through a publish/subscribe model. According to the MQTT protocol, the transmitter client publishes a message to a topic in the broker server, and then the broker server sends the message to the receiving clients who subscribed to that particular topic.

In this example, the Mosquitto is implemented in a Windows computer as the MQTT broker server. To increase security: authentication using username and password, and Transport Layer Security (TLS) certificates are configured. Username and password authentication ensure that only authorized users can access the broker. To create the password file and add a new user, the mosquito password utility is used. One of its key security features is that it stores passwords in a hashed format rather than in plain text. Hashing algorithms such as SHA512, SHA256, and PBKDF2 are designed to be one-way functions, meaning it is computationally infeasible to reverse the hash to obtain the original password. This ensures that even if someone gains access to the password file, they cannot easily retrieve the actual passwords.

The purpose of using TLS certificates in an MQTT broker and client device is to establish a secure, encrypted communication channel between them. TLS certificates provide authentication of both the broker and the client, ensuring that both parties can trust each other's identity before exchanging data. TLS ensures that data transmitted over the network are encrypted, protecting them from eavesdropping, tampering, or man-in-the-middle attacks. When TLS is used in the Mosquitto MQTT broker, common encryption algorithms include Advanced Encryption Standard (AES) for symmetric encryption, Rivest-Shamir-Adleman (RSA) or Elliptic Curve Cryptography (ECC) for key exchange and authentication, and SHA-256 for hashing to ensure data integrity, depending on the negotiated cipher suites. To configure TLS certificates in the Mosquitto MQTT broker, the necessary certificates are generated: a CA certificate, a server certificate, and the corresponding private key using OpenSSL. These certificates are used to encrypt communication between the broker and clients. The certificates are then copied to a secure location on the server. The Mosquitto configuration file is modified to enable TLS by specifying the paths to the CA certificate, server certificate, and private key, and setting the listener port to use TLS. When connecting, clients must also be configured to use TLS and use the same CA certificate to verify their identity.

To enable public access to the MQTT broker server from any location, it needs a fixed address and port number. The host computer's private IP is dynamically assigned by the router's dynamic host configuration protocol (DHCP) server, and it can change based on the devices connected to the local network. To resolve this, the private IP of the host computer is made static, and port forwarding is set up in the router. The port forwarding mechanism directs incoming data packets from the Internet to the MQTT broker server. Additionally, the listener port is opened in the Windows Firewall settings. A memorable and user-friendly name for the router's public IP is assigned using No-IP—a free dynamic domain name system (DDNS) service. Although the router's public IP, assigned by the Internet service provider (ISP), does not change often, it may change after a few months or when the modem is restarted. To handle this, Dynamic DNS Update Client software is installed on the host computer, which continuously checks for changes in the public IP and automatically updates the DNS at No-IP when necessary.

Over-the-Air (OTA) Server: An OTA server is essential for managing firmware and security updates for IoT devices like gunshot detectors, without requiring physical access to the devices. Once the devices are installed, especially in hard-to-reach or critical locations such as schools or offices, manually updating them can be costly and time-consuming. OTA updates allow system administrators to push new firmware or security patches remotely, ensuring that the devices remain secure and functional over time. This approach minimizes downtime, enhances device performance, and ensures quick deployment of updates in response to newly discovered vulnerabilities, all without having to remove or manually reconfigure each device.

In this example, the OTA server is written in Python and hosted on the same computer where the MQTT broker is hosted. To facilitate production-level deployment, the server uses the Waitress WSGI HTTP server to handle requests. By using Waitress, the server can handle multiple requests simultaneously, making it suitable for environments where numerous devices may request firmware updates concurrently. The server is configured to listen on a particular port number and the port is opened in the Windows Firewall settings. To access the server publicly, port forwarding is configured in the router.

The OTA update server implements HTTP Basic Auth to ensure secure access to its endpoints, protecting sensitive data such as firmware files. It verifies user credentials stored in an external file (e.g., ‘users.txt’). Usernames and hashed passwords are loaded from this file, allowing dynamic updates without modifying the server code. A separate Python script is used by the server administrators to add new users and hashed passwords; and append them to the file. Upon successful verification by the server, the client device is granted access to the server's resources, ensuring that only authorized devices can access version information or trigger firmware updates.

The server provides a dedicated endpoint for retrieving the current firmware version of a specified hardware version. The /get_fw_ver/<hw_ver> endpoint serves as a mechanism to query the version of firmware that must be deployed for a particular device type. The server reads the firmware version from a text file (e.g., ver.txt) stored in a directory specific to each hardware version. This design enables efficient version control and ensures that the correct firmware version is served to requesting devices.

The core functionality of the OTA server is delivered through the /get_fw/<hw_ver> endpoint, which provides the actual firmware update files. Upon receiving a request, the server first checks the corresponding ver.txt file to determine the latest firmware version for the specified hardware. It then locates the appropriate firmware package in .zip format (e.g., fw_v1.zip). The zip file contains 3 files: python code for gunshot detection and notification, python code for the server to access the recorded audio files, and the TensorFlow Lite deep learning model. If the Zip file is found, it is securely transmitted to the client using Flask's send_file function. Error handling and logging are implemented to manage scenarios where files are missing or inaccessible.

Device for Gunshot Detection and Notification: The gunshot detection device monitors environmental sounds and classifies them as either gunshot or non-gunshot. Upon detecting a gunshot, the device sends a notification to smartphones over the Internet using the MQTT protocol and also saves the gunshot sound files locally on the device. Initial Wi-Fi and user configuration of the device, and controlling the device, such as enabling and disabling the device, is managed through the developed smartphone app. A brief overview of the device's hardware and firmware is provided below.

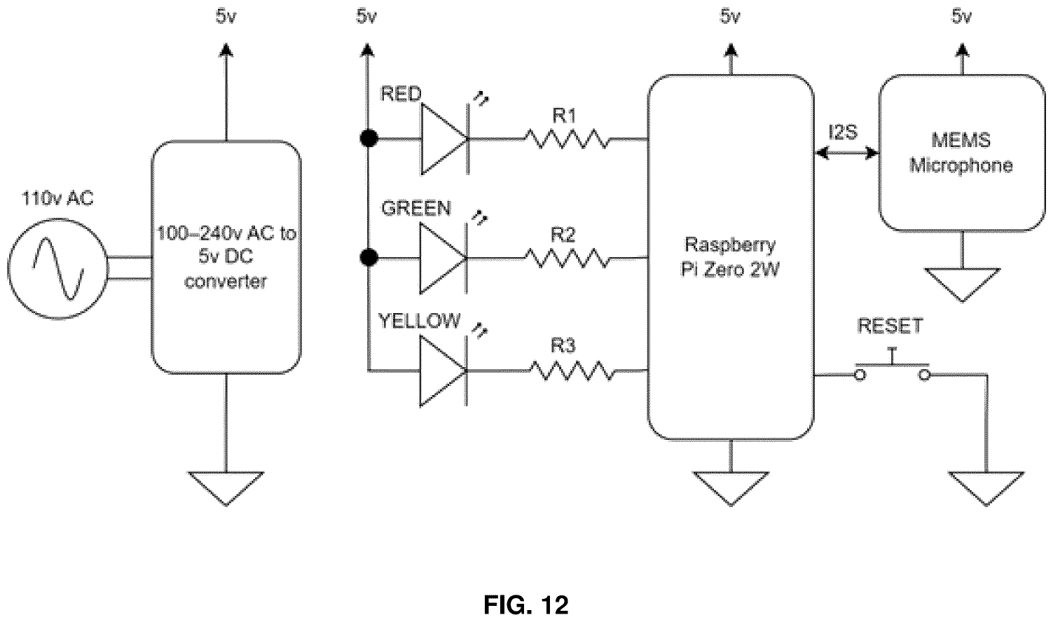

Hardware: The hardware block diagram of the gunshot detection and notification device is shown in FIG. 12. The Raspberry Pi (RPi) Zero 2W is used as the main processing and communication unit. It has a 1 GHz quad-core 64-bit Arm Cortex-A53 CPU, 512 MB of SDRAM, 2.4 GHz 802.11 b/g/n Wi-Fi, Bluetooth Low Energy (BLE), onboard antenna, microSD card slot, and Hardware Attached on Top (HAT) compatible 40-pin GPIO header. It also has a compact 65 mm×30 mm form factor. A MEMS microphone breakout is interfaced with the Raspberry Pi Zero 2W using the I2S interface for mono channel (e.g., left channel) input. The breakout board contains a compact, low-power microphone comprising of a high-performance SISONIC acoustic sensor, a serial analog-to-digital converter, and a signal conditioning interface that outputs audio in the standard 24-bit I2S format. The I2S interface facilitates integration with digital processors eliminating the need for an external audio codec or sound card. The Acoustic Overload Point (AOP) of this microphone is 120 dB. A sound level of 120 dB is equivalent to very loud noises, such as a rock concert, a jet engine from a short distance, or a gunshot. Thus, it can accurately capture sound levels up to 120 decibels without significant distortion. Three LEDs are connected to the GPIO ports of the Raspberry Pi in the active low configuration: a yellow LED to indicate listening mode, a green LED to indicate Internet connectivity, and a red LED to indicate gunshot event. Three current limiting resistors R1, R2, and R3 of 330Ω are used for the LEDs. A push button switch is interfaced with a GPIO pin to reset the device manually by the user. For the power supply, a 100-240 v AC to 5 v DC converter module is used. It can provide a maximum of 600 mA current and 3-watt power. A printed circuit board (PCB) containing the MEMS microphone connector, three LEDs with resistors, and the reset switch is developed, and connected to the 40-pin header of the Raspberry Pi as a HAT. A casing with a wall-outlet AC plug is used to hold the electronics.

Firmware: The Raspberry Pi Zero 2W is equipped with a 32 GB SD card, running Raspberry Pi OS 32-bit, which supports inferencing TensorFlow Lite models. The application software is written in Python, with all necessary packages installed on the system. After boot, two Python programs operate concurrently in separate threads: one for initializing the device, Wi-Fi provisioning, detecting gunshots, and OTA update management, and the other for accessing the recorded gunshot sounds.

Initializing device: The device initialization process involves setting up the hardware and software components necessary for real-time gunshot detection. Upon boot, the Raspberry Pi Zero 2W configures its GPIO pins for various LED indicators and a reset button, ensuring proper signaling during operation. The system also loads the pre-trained Tensor-Flow Lite model into memory, preparing the neural network for real-time classification of audio data. Additionally, the sound input subsystem is configured by initializing the I2S microphone and setting up the audio stream for continuous capture at the 44.1 kHz sampling rate.

The MQTT client is also set up for communication with the MQTT broker, ensuring that detected gunshot events are transmitted in real-time. To ensure communication security, the MQTT client is configured with the same CA certificate as described above, which provides encrypted communication over TLS. Upon successful connection to the MQTT broker, the device immediately sends a device status update to the user's smartphone indicating its connected status. In addition, the device subscribes to its specific MQTT topic, GSD_DEVICE_CMD/<DeviceID>, where <DeviceID> is the unique identifier for the device, allowing it to receive control commands from the user's smartphone. A “last will” message is configured within the MQTT client, allowing the device to notify the MQTT broker and the users if an unexpected disconnection occurs. To maintain connection stability, the MQTT client is configured with a keep-alive interval of 10 s. This setting ensures that the device periodically sends ping messages to the broker to verify that the connection remains active. If no communication is detected within the 10-s window, the MQTT broker can assume the device has disconnected and trigger the “last will” message.

A callback function, MQTT_on_message( ), is a key component of the system's communication architecture, enabling real-time command from the user's smartphone to the device. This function is triggered whenever the device receives a message from the MQTT broker for the topic GSD_DEVICE_CMD/<DeviceID>. The smartphone app can send various commands to the device, such as enabling or disabling the gunshot detection functionality, requesting the device's local IP address, or initiating an OTA update. Upon receiving a command, it parses the payload and executes the appropriate action. For example, if the command is to enable the device, the system activates its detection mode by setting the isDeviceEnabled flag.

Upon boot, the init_ota( ) function determines whether all tasks of the OTA update have been completed. Lastly, any previous device status, such as enabled or disabled states, is read from the system files to determine whether the device should start in an active or inactive mode.

Wi-Fi provisioning: This function in the RPi device initiates the process of establishing a network connection, either by connecting to a pre-configured Wi-Fi network or setting up a hotspot for Wi-Fi provisioning. If the system detects that no active Wi-Fi connection is available, it automatically starts a hotspot, turns on all three LEDs, and waits for a smartphone app to provide Wi-Fi configuration information. The communication protocol between the RPi and the smartphone app is established through a socket connection, allowing the app to send Wi-Fi credentials securely to the device.

The smartphone app is responsible for scanning available Wi-Fi networks and allowing the user to select the desired network, and password if required. Once the user provides this information, the app opens a socket connection to the device hotspot and transmits the Wi-Fi configuration data in a structured format (e.g., security type, SSID, and password). The Python program running on the device receives these data through the socket, parses them, and attempts to connect to the specified Wi-Fi network. If successful, the device switches from hotspot mode to the configured network, turns off all the LEDs and continues the normal operation. The app verifies the successful Wi-Fi connection of the device by receiving the device serial number, <DeviceID>, which is needed by the smartphone to send commands to the device using MQTT.

Detecting gunshots: The code of the main loop governs the main operations, including audio recording, feature extraction, gunshot classification, and system state management.

At the beginning of each iteration of the loop, the device first checks if it is enabled by verifying the value of the isDeviceEnabled flag. If enabled, the system captures an audio sample using the RecordAudioSample( ) function. Here, the function turns on the yellow LED and waits until all the 1 s audio samples are read. It then turns off the yellow LED and leaves the function. The function does not terminate the recording process once it finishes reading the data. Instead, the audio stream continues running n the background, allowing i continuous audio capture while doing feature extraction and classification. The average delay between this subsequent function call is 35.2 milliseconds, which is ess than 1 s. This design ensures that no audio data are lost due to the delay in the remaining code of the loop. The audio data are then passed to the GenerateFeatures( ) function, which extracts both time-domain and frequency-domain features, as described above.

After generating the 2D features, f, the system processes them using overlapping windows, a technique that enhances the robustness of detection. Here, the number of overlaps, v, is set as 4 and offset as 16, calculated by dividing total feature columns=64 by v=4. Unlike the approach in Example 1, where each iteration analyzes new 1 s audio data, this system creates overlap by combining the last columns of the previously generated feature matrix, fp, from the last audio sample with the beginning columns of the current feature matrix, f, from the new audio sample. For instance, the last ¾th of pfp columns are concatenated with the first ¼th of the f column in the first iteration, then the last 2/4th of fp columns are concatenated with the first 2/4th of the f column in the second iteration, and so on. Finally, fp is set as f for the next cycle. This overlapping mechanism is essential for capturing transient audio events, such as gunshots, which may not be fully captured within a single window. By combining features from consecutive audio samples, the system increases the likelihood that the important characteristics of a gunshot are preserved across multiple windows, reducing the chances of missing critical audio patterns due to the boundaries.

Once the feature matrix is constructed, it is passed to the ClassifySound( ) function. This function employs the pre-trained convolutional neural network (CNN) model to classify the sound based on the extracted features. The CNN, optimized for real-time execution via TensorFlow Lite, analyzes the combined feature set and generates a probability score indicating the likelihood of the detected sound being a gunshot. If the score exceeds the 0.5 probability threshold, the sound is classified as a gunshot. If a gunshot is detected, the system immediately triggers the HandleGunshotEvent( ) function, which manages all subsequent actions. These include publishing an MQTT message on the topic GSD_OBSERVER/<DeviceID> containing a timestamp, saving the audio data as a WAV file for forensic purposes, and turning on the red LED as a visual indicator.

In the main loop, the UpdateMQTTConnectionStatus( ) function continuously checks whether the device is connected to the MQTT broker and updates the status of the green LED accordingly. If the connection is lost, the device attempts to reconnect automatically. Finally, the CheckResetButton( ) function monitors the physical reset button connected to the Raspberry Pi's GPIO. If the button is pressed, the device measures the duration of the press to determine whether to perform a soft reboot or shut down the system. A short press triggers a reboot, allowing the system to restart. A long press, on the other hand, results in a complete shutdown.

OTA update management: The CheckForOTAUpdate( ) ensures that the system stays up-to-date with the latest firmware version without manual intervention. In each loop of the firmware, it checks the current time with the scheduled OTA update time. The scheduled OTA time is randomized based on the unique identity of the device to avoid overloading the server with many requests at the same time. If the current time matches the scheduled OTA time, the system initiates a series of operations to communicate with the OTA server that includes: verifying the availability of a new firmware version, downloading the update, installing it, restating, and deleting old files.

The first step in the OTA update process is to determine whether a new firmware version is available. When the update process is triggers, the device establishes a secure HTTP connection with the OTA server. This communication is facilitated through the Flask-based OTA server running on a designated IP and port as described above. It then sends a GET request to the server's/get_fw_ver/<hw_ver> endpoint, where <hw_ver> represents the hardware version of the device. This endpoint checks the ver.txt file on the server, which contains the current firmware version for the specified hardware version. Upon receiving the request, the OTA server verifies the identity of the device using HTTP Basic Authentication. If authentication is successful, the server reads the ver.txt file, retrieves the current firmware version, and sends it back to the device in the HTTP response. The device then compares the received firmware version with its own. If the versions differ, indicating that a new update is available, the device proceeds with the update process.

Once the system confirms that a new firmware version is available, the device initiates the downloading and installation of the update. This function establishes another secure HTTP connection with the OTA server, targeting the /get_fw/<hw_ver> endpoint. The firmware files are packaged based on hardware version compatibility, preventing the installation of firmware on incompatible devices. The OTA server responds by sending the firmware file packaged as a Zip archive. The Zip file is streamed directly to the device, ensuring minimal latency. Upon receiving the Zip archive, the device uses Python's zip file module to extract the firmware files into the appropriate directory on the device.

After extracting the files, the device updates a shell script with the new filenames, which lists the Python files that will run after the system boots. It also writes in an ota.dat file: the version number of its current firmware and the flag isUpdatingDone as False, indicating that its current firmware files still need to be deleted by the new firmware after the boot, as the currently running Python script cannot delete itself. Finally, the system triggers a reboot to apply the firmware changes, ensuring that the updated firmware is executed on the next boot. Upon boot, it checks the ota.dat file to determine whether all tasks of the update have been completed. If the flag isUpdatingDone is set to False, the function reads the version of the previous firmware that can now be deleted. The system then proceeds to remove the old version's files, such as outdated Python scripts and model files, and sets isUpdatingDone as True. This function is crucial for freeing up space for future updates.

Secure gunshot audio file access via local network: A secure web server using Flask on the RPi device is implemented to allow access to recorded gunshot audio files over the local Wi-Fi network. The server employs HTTP Basic Authentication with password hashing to ensure that only authorized users can access the files. SSL/TLS encryption ensures secure transmission of data between the client (smartphone or desktop) and the server, protecting sensitive information like passwords and audio files. The server also features a password change functionality. Users can update the administrator password through a web form, and the updated password is securely hashed and stored in a file.

Gunshot audio files, stored in a specific directory, are dynamically listed on the homepage, and users can click links to download the files. File access is handled by Flask's ‘send_from_directory( )’ method, ensuring that only files in the designated directory are accessible.

Smartphone App: The smartphone app, developed for the Android platform, uses the MLWiFi library to configure the RPi device's Wi-Fi settings. The app scans for available 2.4 GHz Wi-Fi networks and fills a combo box. The user then selects the SSID and enters its password in a textbox. The app then connects to the device's hotspot (SSID: “gsd_hotspot”). Upon establishing the connection via a socket, the app sends the selected network's SSID and password to the device. The device receives these credentials and attempts to connect to the specified network. Once the device is connected to the Wi-Fi, it sends the <DeviceID> to the smartphone app, and the device is added to a list. Users can add multiple devices to their list by configuring Wi-Fi, and the app automatically subscribes to MQTT topic GSD_OBSERVER/<DeviceID> associated with each device for real-time monitoring.

The app initializes the MQTT client at boot, ensuring it runs continuously as a background process, even when the app is not open. This MQTT client connects with the MQTT broker using authentication credential with SSL encryption; and it reconnects automatically if disconnected, ensuring that real-time communication with the device remains uninterrupted. The app can send MQTT messages related to device status such as connected or disconnected, gunshot notifications, and can send control commands, keeping the system responsive to user inputs and sensor events.

The app receives gunshot detection data through a call back function which is executed whenever MQTT massage arrives. When a gunshot event is detected, the app logs the event along with the timestamp and displays the information in real time. A phone notification is also raised to immediately alert the user. Additionally, when the user clicks on the logged event, the app opens Google Maps, showing the exact location where the gunshot was detected. This feature relies on the GPS data associated with the device. The detailed process of device configuration, including the input of GPS coordinates and storing them in the database, is described in Example 1.

To access the recorded gunshot audio files stored on the device, the app sends an MQTT command to topic GSD_DEVICE_CMD/<DeviceID> requesting the device's latest local IP address, as this address may change depending on the network. Upon receiving the device's IP via MQTT, the app opens a browser to access the device's file server, allowing the user to play and download sound recordings directly from the device. To ensure security, access to these files is protected by HTTP Basic Authentication and encrypted using SSL/TLS. This provides a secure and dynamic way to access event-specific audio files stored on the device. The app allows users to send commands to the devices on the topic GSD_DEVICE_CMD/<DeviceID>, such as enabling or disabling the device, initiating over-the-air (OTA) updates, or requesting the current IP address. These commands are sent via MQTT, ensuring secure and efficient control over multiple devices.

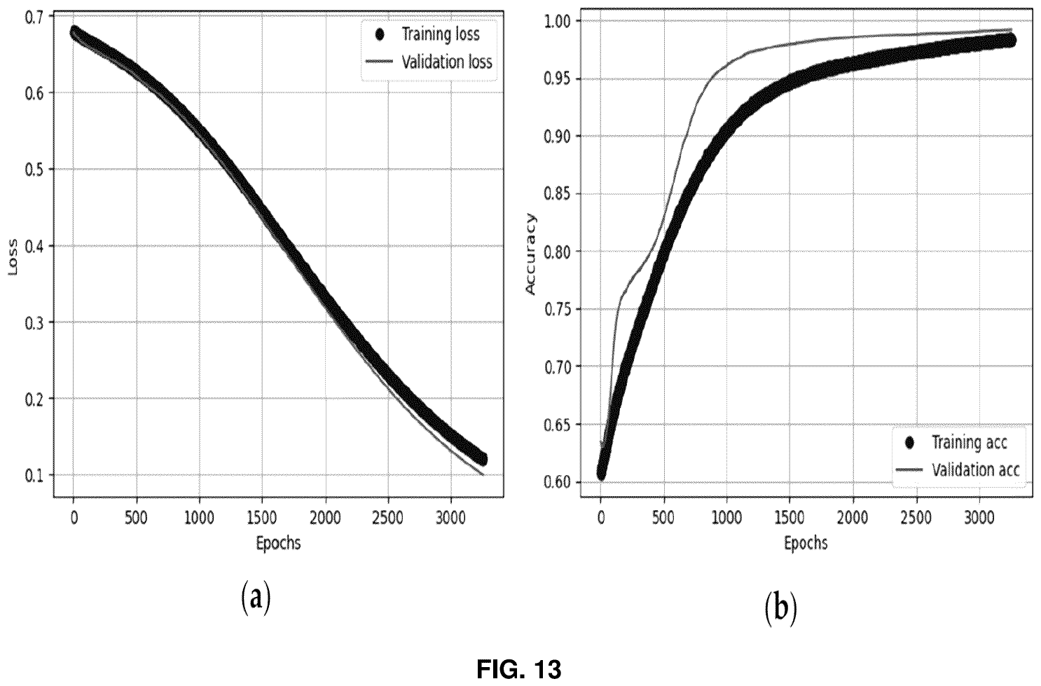

Deep Learning Model Results: The deep learning model was trained and validated concurrently until either the validation loss dropped to 0.01 or less, or the model completed 50,000 epochs, whichever occurred first. The batch size for both training and validation was set to 4096. The learning rate was configured at 1×10⁻⁶, with a learning rate decay of 1×10⁻⁷. FIG. 13 illustrates the loss versus epochs and accuracy versus epochs trends for both the training and validation datasets. These graphs clearly show a steady reduction in loss and a simultaneous rise in accuracy as the epochs progress. The model reached a validation loss of 0.01 by the 3255 epochs, concluding the training in 27 min and 41 s. Notably, the training and validation datasets reached an accuracy of approximately 98% and 99% respectively, after the 3255 epochs.

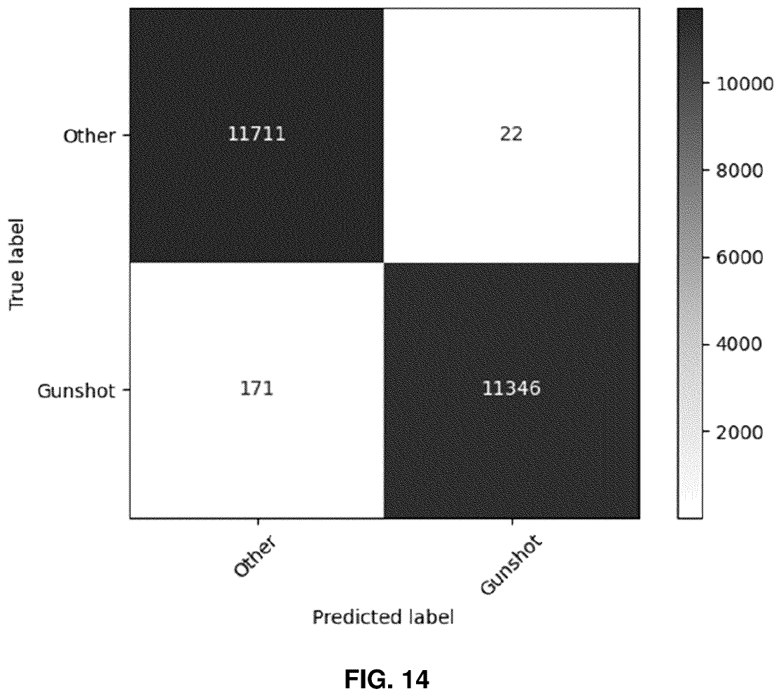

Once training and validation were completed, the model, which consists of 2277 learned parameters (including filters, weights, and biases), was saved and was then tested on an unseen dataset of 23,250 samples. During this testing phase, the model recorded a loss of 0.0995 and an accuracy of 99%. Table 5 summarizes the loss and accuracy for the training, validation, and test datasets, demonstrating that the model's accuracy is consistent across all sets and its strong generalization capability. The confusion matrix for the test dataset is shown in FIG. 14, while Table 6 provides the precision, recall, and F1 scores for the test dataset.

TABLE 5
The loss and accuracy of the training, validation, and test datasets.

| | Training | Validation | Test |
|---|---|---|---|
| Loss | 0.1205 | 0.1000 | 0.0995 |
| Accuracy | 0.9839 | 0.9916 | 0.9917 |

TABLE 6
The precision, recall, and F1-scores of the test dataset.

| | Precision | Recall | F1-Score |
|---|---|---|---|
| Gunshot | 1.00 | 0.99 | 0.99 |
| Other | 0.99 | 1.00 | 0.99 |

Prototype Testing Result: A working prototype of the proposed system, consisting of three gunshot detector devices, server, and smartphone applications, has been developed and successfully tested. The gunshot detector device includes a custom-made PCB HAT and is housed in a casing with dimensions of approximately 7.6×5.1×5.1 cm. The device is programmed based as described above and is configured to automatically execute programs upon boot. On the RPi Zero 2W, feature generation takes an average of 21.76 milliseconds, and a single inference using the TF-Lite deep learning model takes 3.7 milliseconds. Depending on internet latency, the MQTT broker may take from 10 ms to 100 ms to send the notification. Thus, the maximum delay to receive the smartphone notification is 21.76+3.7+100=125.76 ms.

The device's current consumption was measured using a Keysight N6705C DC power analyzer equipped with the N6781A source/measure unit (SMU) module, with the voltage set to 5 V. During normal operation, the current consumption ranged from approximately 200 mA to 400 mA, which is below the maximum 600 mA limit of the DC power supply module used in the device.

The MQTT broker and OTA server were running on an Internet-connected computer. After the gunshot detector devices were powered up, all three LEDs turned on to indicate that they were waiting for Wi-Fi provision from a smartphone. The device's Wi-Fi is then configured using the smartphone app. Using the app, the Wi-Fi of the devices is configured and the devices are added to the app to receive notifications. The devices then went to the listening mode indicated by the blinking of the yellow LED, and it turned on the green LED to indicate a successful connection with the MQTT broker.

The gunshot detector was tested inside a lab environment by performing actual shootings using two types of blank guns: ZORAKI M906 semi-automatic blank pistol and Ekol ASI fully-automatic blank machine gun. The ZORAKI blank pistol can only make a single shot, whereas, the Ekol blank machine gun can make single or multiple shots in one trigger. The gunshot detector device was placed in the lab and in the building corridor, and shots were fired from different distances. In Table 7, the gunshot detection accuracy in single-shot mode at different distances is shown. Here, it is seen that it can detect gunshots with an accuracy of 100% up to 40-feet distances. After that, the accuracy reduces to 50% from a distance of 50 feet to 80 feet, and, finally, the accuracy becomes 0% when the distance is more than 80 feet. In Table 8, the gunshot detection accuracy with the Ekol machine gun in the research lab at different distances is shown. In this test, the machine gun was switched to automatic mode and it shot multiple ammos in one trigger. Here, it is seen that the detection accuracy is 100% for different numbers of ammos and at different distances. The sound pressure levels (SPL) were measured using a decibel meter in the lab. The SPL was around 117 dBA in the lab for the gunshot, however, it reached over 130 dBA when more than 7 ammo were fired in a single trigger by the machine gun.

The disclosed system was also tested for situations when a gunshot event happens in the presence of background noise. Background noise was created by playing sound effects of people talking in school hallways, thunderstorms, and nursery rhymes from a smart TV. The SPL was around 30-40 dBA in the absence of the background noise, and the SPL increased in the range of 60-70 dBA in the presence of the background noises. Using the Zokari pistol, gunshots were fired from different distances and the device detected the gunshots with 100% accuracy as shown in Table 9. No false alarm was generated due to the background sounds.

TABLE 7
Gunshot detection accuracy in single-
shot mode at different distances

| | Number | | Distance | Detection |
|---|---|---|---|---|
| Blank Gun Type | of Shots | Location | (Feet) | Accuracy |
| Zokari pistol | 5 | Research lab | 16 | 100% |
| | 5 | | 32 | 100% |
| Ekol machine gun | 4 | | 16 | 100% |
| | 6 | | 32 | 100% |
| | 2 | Building corridor | 10 | 100% |
| | 2 | | 20 | 100% |
| | 2 | | 30 | 100% |
| | 2 | | 40 | 100% |
| | 2 | | 50 | 50% |
| | 2 | | 60 | 50% |
| | 2 | | 70 | 50% |
| | 2 | | 80 | 50% |
| | 2 | | 90 | 0% |
| | 2 | | 100 | 0% |

TABLE 8
Gunshot detection accuracy in multiple-
shot mode at different distances

| Number of Ammos in a Shot | Distance (Feet) | Detection Accuracy |
|---|---|---|
| 2 | 16 | 100% |
| 3 | 32 | 100% |
| 4 | 16 | 100% |
| 5 | 32 | 100% |
| 6 | 16 | 100% |
| 7 | 32 | 100% |
| 8 | 16 | 100% |
| 9 | 32 | 100% |

TABLE 9
Gunshot detection accuracy in the presence
of background noise at different distances

| | Distance | Number | Detection |
|---|---|---|---|
| Background Noise | (Feet) | of Shots | Accuracy |
| Talking in school hallway | 16 | 3 | 100% |
| | 32 | 3 | 100% |
| Thunderstorm | 16 | 3 | 100% |
| | 32 | 3 | 100% |
| Nursery rhymes | 16 | 3 | 100% |
| | 32 | 3 | 100% |

During testing, different sounds other than gunshots were generated such as talking, playing movies, clapping, laughing, etc. and they were successfully detected as nongunshot sounds. To test the device for a false alarm, balloons were popped and gunshot sounds from TV were played in front of it, and the device was taken outside on July 4^{th} night (the Independence Day of the USA) when the fireworks were happening. The device did not detect those sounds as gunshot sounds and did not create any false alarms.

The smartphone app received notifications in less than a second after the device detected the gunshot. The detailed process of user and device configuration, including the input of GPS coordinates and storing them in the database, is described in Example 1.

The OTA update was tested by configuring a new firmware version in the OTA server. The devices successfully updated their firmware from the OTA server at the scheduled time. The proposed devices were also tested by unexpectedly removing them from power. The MQTT broker successfully sent the last will messages to the smartphone indicating its disconnection status. When the devices were again powered on, the smartphone successfully received messages of their connected status. Commands from the smartphone app to the devices were sent, such as enable/disable a device, OTA now, and accessing recorded gunshot sounds that are stored on the devices, and they worked as expected. Authentication and password change features worked successfully to access the recorded gunshot sounds.

Summary: The same sound was recorded using the custom sound recording device and the gunshot detector device. The time domain signals of the two recordings were plotted and it was found that the amplitude of the sound recorded by the gunshot detector device is 1.44 times higher than the custom recording device that was used to develop the training dataset. Due to this mismatch, the gunshot detector device became too sensitive and was giving frequent false alarms. The problem was then solved by dividing the amplitude of the recorded signal by 1.44 and then generating the features for classification.

During testing, it was found that if loud screaming is done by placing the mouth within around 30 cm distance of the microphone, the gunshot detector device classifies it falsely as a gunshot. However, if the distance is farther, the screaming is not classified as a gunshot. To solve this, more screaming sounds can be added to the training dataset of non-gunshot sounds.

It is observed from Tables 7 and 8 that the device was able to detect gunshot sounds from the machine gun, even though the deep learning model was only trained with the dataset made with blank pistol sounds. It shows the model is well generalized and is expected to detect gunshot sounds from different types of guns. The a dataset of gunshots can be expanded with different types of guns and retraining the model, testing the system in shooting range with guns that throw bullets instead of blanks, and performing ethical hacking on the system to find further security variabilities.

Message Queuing Telemetry Transport (MQTT), Firebase Cloud Messaging (FCM), and Short Message Service (SMS) are three popular technologies for real-time notification delivery. MQTT is a lightweight, publish-subscribe messaging protocol designed for resource-constrained environments like IoT systems. It supports quick message delivery, multiple Quality of Service (QoS) levels for reliability, and robust security features such as SSL/TLS encryption. Additionally, MQTT is available as open source and does not rely on third-party platforms, offering greater control and flexibility. In contrast, FCM, a cloud-based push notification service provided by Google, is aimed at mobile applications and offers features like device targeting and cross-platform compatibility. However, its dependency on Google's infrastructure and potential latency issues, especially during high traffic periods, can make it less suitable for critical applications like gunshot detection. SMS requires a GPRS modem in the embedded systems, adding hardware overhead. Additionally, SMS incurs a per-message fee and makes it expensive. For such scenarios, MQTT's low latency, lightweight nature, security features, and independence from external services make it a more reliable and efficient choice for ensuring timely notifications.

According to the Nyquist theorem, the sampling rate must be at least twice the highest frequency present in the signal to capture it accurately. Human hearing typically ranges from 20 Hz to 20,000 Hz, so a sampling rate of 44.1 kHz ensures that frequencies up to 22,050 Hz (just above human hearing) are captured without aliasing. The proposed system captures, records, and classifies gunshot and non-gunshot sounds, which might include sounds anywhere in the entire hearing frequency range. Thus, lowering the sampling rate may distort the signal and may lead to misclassification. If a low-resource microcontroller having limited RAM and speed is used, then it might be necessary to reduce the sampling rate and resolution, and compromise accuracy. However, the Raspberry Pi Zero 2W has sufficient RAM and processing speed to store 1 s of sound at a 44.1 kHz sampling rate with 32-bit resolution, which requires approximately 176.4 kB of memory for mono audio. With 512 MB of RAM and a 1 GHz quad-core processor, the device can handle these data efficiently without compromising accuracy or requiring a reduction in resolution. The device can be implemented in low resource microcontroller with experiments at a lower sampling rate and resolution.

In Example 1, only frequency-domain features were used. It was observed that the loudness of the gunshot sound is important for accurate classification. Neglecting amplitude-related features led to false alarms, particularly when the classifier encountered low-volume gunshot sounds from TVs or gaming devices. In real-world scenarios, amplitude-related features play a significant role in distinguishing real gunshots from potential false alarms. In this example, both time and frequency-domain features are used. Real-time testing with blank guns demonstrated that the proposed system achieves 100% accuracy in detecting gunshot sounds within a 40-foot range, as shown in Table 7. Moreover, the system successfully passed false alarm tests involving balloon pops, fireworks, and gunshot sounds from action movies.

### Example 3

This example provides illustrative embodiments of a gunshot detection system, associated gunshot detection device, and related software.

FIG. 1 illustrates gunshot detector system including gunshot detector devices (b) installed at various locations or environments (a). The observers could be smartphones or desktop PCs that have added a gunshot detector device to observe. They are shown in (d) and (e) in FIG. 1. Whenever a gunshot happens, these smartphones and PCs will be notified. A central server is shown in (c) in FIG. 1, and it runs the MQTT broker, OTA server, MySQL database, and the central server app. A customer service app is used by customer service and is shown in (g) in FIG. 1. A data analytics app is used by the company management for data analytics and is shown in (h) in FIG. 1.

Gunshot Detector Device: The gunshot detector device is an advanced electronic system designed to detect gunshot sounds in indoor environments and notify emergency responders in real time. The device is implemented using an ESP32-S3-WROOM N8R8 microcontroller, interfaced with an I2S microphone (SPH0645LM4H) and an RGB LED (WS2812), and includes HLK-PM03 AC-DC 220/110V to 3.3V converter module. It can be placed in various positions such as attached to a wall power outlet, mounted on the ceiling, or placed on a table. Features of the gunshot detector device include: (1) Real-Time Gunshot Detection: Utilizes a deep learning model based on a convolutional neural network (CNN) to detect gunshot sounds with 99% accuracy. (2) Immediate Notifications: Sends real-time notifications to the Observers via the Internet using secured MQTT protocol. (3) Verification for False Alarm: After a gunshot, the Device sends recorded audio for several seconds to the central server using MQTT. (4) Connectivity: Uses local Wi-Fi with different security features to connect to the Internet. After installation, the Device connects with the user's smartphone using Bluetooth Low Energy (BLE) to configure the Wi-Fi credential of the Device. The Device connects with the MQTT broker server as a client. (5) Firmware Over-the-Air (OTA) Updates: Capable of receiving firmware updates over the air. (6) Mounting Options: Wall outlet, ceiling mount, table placement. Functional descriptions of the gunshot detector device are described below.

Initialization: The device initializes its components, including the microcontroller, microphone, RGB LED, and network connections. It reads configuration data from EEPROM and connects to the Wi-Fi network. The real-time clock is synchronized with an NTP server in the UTC zone. Sends its enable/disable, send sound, and connection status to all observers and the central server.

Wi-Fi Configuration via Bluetooth: The device uses Bluetooth Low Energy (BLE) to communicate with a smartphone app for initial Wi-Fi setup. Users can select the available Wi-Fi SSID and send selected network credentials to the device. The device stores these credentials in EEPROM for persistent Wi-Fi connectivity.

Gunshot Detection: The I2S microphone captures audio data, which is processed by the ESP32 microcontroller. The deep learning model classifies the audio data to detect gunshots. If a gunshot is detected, the device sends real-time notifications to a predefined MQTT server and connected smartphones.

Deep Learning Model and Inference: The deep learning model is a CNN trained to classify gunshot sounds. A custom dataset for gunshot sounds is developed and used. Details of the deep learning model is provided in Example 2. Features used include time-domain features (Absolute mean, max, min, standard deviation, and difference of audio samples) and frequency-domain features (Mel-frequency cepstral coefficients (MFCCs) are calculated from the audio signal). The inference process includes several steps: Audio data is captured and processed in real time. Time-domain and frequency-domain features are extracted. The CNN model uses these features to classify the audio signal. If a gunshot is detected, the device triggers notification and recording actions.

Notification and Data Transmission: Notifications include the date and time of the gunshot and the location. The device sends recorded audio for several seconds to the server using MQTT for post-crime scene analysis and false alarm detection, with subsampling to reduce data size.

Firmware Updates: The device receives command from server for firmware updates at scheduled times and performs OTA updates if new firmware is available. The OTA process is secured with username and password authentication.

LED Indication: The RGB LED provides visual feedback for various states, such as initialization, Wi-Fi connection status, gunshot detection, and firmware updates: Connecting to Wi-Fi and BLE advertising: Blink Blue; Connecting to Wi-Fi or MQTT broker: Yellow; BLE connected: Blue; Gunshot listening: Blink at 0.1 Hz in green; Gunshot detected and sending data: Blink Red; OTA or MQTT command received: Purple; Error: White

Error Handling and Recovery: The device includes error-handling mechanisms to recover from network failures, power outages, and other issues. It periodically checks and re-establishes connections if needed. When connected or disconnected, it sends its connection status to all observers and the central server.

MQTT Commands: These commands can be sent to the Device from the user's smartphone/PC or customer service app. The Device subscribes to a topic related to its unique device ID so that it can receive the MQTT commands. Commands include: Disable Device: Disables the gunshot detection functionality. Sends its enable/disable status to all observers and to the central server; Enable Device: Enables the gunshot detection functionality. Disables the gunshot detection functionality. Sends it enable/disable status to all observers and the central server; Restart Device: Restart the device; Perform OTA Update: Initiates an OTA firmware update immediately; Sync Time: Synchronizes the device's real-time clock with the NTP server immediately; Reset Wi-Fi: Resets the Wi-Fi configuration, requiring new credentials to be set via BLE; Send Audio Data: Sets flag to send recorded audio data to the server after a gunshot. Sends its send sound status to all observers and the central server; Stop Sending Audio Data: Clears flag and does not send audio data to the server after gunshot. Sends its send sound status to all observers and the central server; Send Device Info: Sends device information, including firmware version and Wi-Fi configuration, to the server.

Observer App: The observer app is installed on smartphones or desktop PCs from online app stores. This app connects with the MQTT broker server as a client and can access the MySQL database on the server using the Internet. The app contains a user interface for sign-in using email and password, sign-up for a new account, and forgotten password recovery method by email. When creating a new account, it checks for a valid email by connecting with the database. When creating an account, the user sets the time zone, so that gunshots notification times can be converted to the desired time zone. Using GUI, the account email, password, time zone can be changed; logout from account, and the account can be deleted. When signed, it will subscribe to a topic related to the UserID, so that it can receive MQTT messages targeted to that user.

The observer app includes a device management user interface to add, edit, monitor, control, share, and remove devices.

Adding Device: To add a Device, the user's smartphone app scans the BLE devices near it and connects. Adding Device is only available for a user using a smartphone and not available using a PC as it does not have BLE. The user selects the SSID and provides its password to the Device for Wi-Fi configuration. The smartphone app receives the Wi-Fi MAC address of the Device and it is used as DeviceID to uniquely identify a Device. This information is written to and read from the online database. The DeviceID will be checked in the database production table to find whether it is a legitimate device.

Editing Device: The user can set and later edit the different properties of the Device such as its nickname, latitude, longitude, address, room number, and floor. This information is written to and read from the online database.

Control Device: User can control their Devices (such as enable/disable, restart, reset W-Fi configuration, etc.) from their smartphone/PC by sending MQTT commands. If the subscription is ended, then the Device can't be Enabled by the user.

Share Device with Other Users: Users can share one or more devices with other users so that they get notifications when a gunshot is detected by that Device. User can share the device by directly entering target user's account email. The communications for sharing Devices among the different users' smartphones/PC will be done using the MQTT protocol. The user can set permission whether the user of the shared device can reshare it or remotely control the device (such as enable/disable, restart, reset W-Fi, etc.). The target user will receive an invitation in their smartphone app or on PC and can choose to “Accept” or “Decline” the Device. The sender will be notified when the target user has accepted or declined the invitation.

Share Device to Local Police: User can share their Device to the local Police station so that they get notifications when a gunshot is detected by that Device. The local Police stations names can be searched by the smartphone app/PC based on the zip code of the user. The user can set permission whether the Police can reshare it or remotely control the device (such as enable/disable, restart, reset W-Fi, etc.). The Police station will receive an invitation on their PC and can choose to “Accept” or “Decline” the Device. The sender will be notified when the police station has accepted or declined the invitation.

Remove Device: The user can select one or more devices and delete the Devices.

Monitor Device: The user will be able to see the status of each Device such as Online/Offline, Active/Expired subscription, Subscription end date, Enabled/Disabled, and whether to send sound data or not. If the Device goes offline, it will send MQTT's last will message through the broker, and the status will be updated. A user can have several smartphones or PCs. When changes are done using one smartphone, the other smartphone and PC's also must refresh. Synchronization among the devices will be handled gracefully by sending “Refresh” commands using the MQTT protocol.

The observer app includes notification and false alarm verification features. The app will generate a notification and alert sound whenever a gunshot happens to any of its added Devices. When it receives the notification from the Device, it will fetch the Device's location information (such as latitude, longitude, address, room number, and floor) from the online database using its DeviceID. Notification will show the date and time converted from UTC to the user's time zone, and the location of the event. Clicking on the notification will open Google Maps and show navigation to the event location. After a few seconds of the notification, the app will receive the URL for the recorded gunshot sound and the sounds for a few more seconds after the gunshot. The user will be able to play the sound to verify the context and possible false alarms. If any user considers it as a false alarm, then the user can mark the event as “false alarm” and the marking with the username will be notified to all the observers of the device.

Example mobile app user interface screens (e.g., for the observer app installed on a mobile device) include (1) introduction/opening (e.g., sign in or create account); (2) create account; (3) get code for new password; (4) set password; (5) sign in; (6) forgot password; (7) device; (8) add device; (9) select WiFi; (10) select WiFi SSID; (11) connect device to WiFi; (12) device info; (13) share device; (14) share device with other users; (15) share device with police station; (16) invited device; (17) account; (18) change email; (19) get code for new email; (20) time zone; (21) events; (22) subscription.

Central Server: The central server can include four components: (1) MQTT broker, (2) OTA server, (3) MySQL database, and (4) a central server app. The central server can run a secured MQTT broker server. Clients can only connect with it using username and password authentication. The central server can run an OTA server, which runs a secured HTTP server that contains firmware updates and a version information file. Client Devices can only connect with it using username and password authentication. The central server can include a MySQL database, which is an online database including several tables, including a user_tbl (UserID, Password, Default_Wi-Fi_SSID, Default_Wi-Fi_password, Default_WiFi_identity, Default_WiFi_user, Timezone, Name, Email, Zip, isPoliceStation, isActiveAccount), a device_tbl (DeviceID, DeviceNickName, DeviceLat, DeviceLng, DeviceFloor, DeviceRoom, DeviceAddress, DeviceCity, DeviceState, DeviceZip, DeviceCountry, isEnabled, isSendSound, isConnected, isActiveSubscription, SubscriptionEndDate, SubscriptionEndTime), a user_device_tbl (ID, UserID, DeviceID, Perm_share, Perm_en_disable, Perm_restart, Perm_reset_WiFi, Perm_editinfo, Perm_renew_subscribtion), a user_device_invite_tbl (ID, UserID, DeviceID, Perm_share, Perm_en_disable, Perm_restart, Perm_reset_WiFi, Perm_editinfo, Perm_renew_subscribtion), an event_tbl (ID, DeviceID, EventDate, EventTime, DeviceLat, DeviceLng, DeviceFloor, DeviceRoom, DeviceAddress, DeviceCity, DeviceState, DeviceZip, DeviceCountry, isFalseAlarm, LastFalseAlarmMarkerUserID), and a production_tbl (SerialNo, DeviceID, ManufactureDate, ManufactureTime). Clients can only connect with it using username and password authentication.

The central server app subscribes to all Devices in the device_tbl and receives gunshot notifications. It inserts data in the event_tbl of the database. It also gathers sound data coming from Devices, makes sound files, and sends URLs of the sound file to the observers to check for false alarms. It checks for the subscription end date of each Device daily. If the subscription is ended, it sends a Disable command to the Device. If the subscription is activated, it sends an Enable command to the Device. The device may be offline when the command is sent and may not receive it. To solve this, whenever the central server receives the connection status as online from the device, it will check for subscription status and send the enable or disable command accordingly. It will send reminder notifications to the users 3 days before any of their device is expiring subscription (if the users have renewal permission).

Customer Service App: A customer service app can be used by the customer service to help the user. It can access all user and device information. MQTT commands can be issued from here to the devices for diagnostics.

Data Analytics App: A data analytics app can be used, which will contain a GUI to search gunshot events based on user, device, date, time, and location for data analytics.

### Further Aspects

Further aspects of the disclosure are provided below.

In an aspect, the disclosure relates to a method for real-time detection of a gunshot, the method comprising: capturing, via a detection device, audio of an environment of the detection device, the captured audio comprising a time-domain audio signal; transforming, via one or more processors of the detection device, the time-domain audio signal into a Mel-frequency cepstral coefficient image; determining, via the one or more processors, whether a sound of the gunshot is captured in the audio by applying a convolutional neural network (CNN) to the Mel-frequency cepstral coefficient image; and responsive to determining the sound of the gunshot is captured in the audio, transmitting, via the detection device, a detection notification to a computing device.

In a refinement, transforming the time-domain audio signal into the Mel-frequency cepstral coefficient image comprises: partitioning, by the one or more processors, the time-domain audio signal into a plurality of time frames; transforming, by the one or more processors, the time-domain audio signal into a frequency-domain audio signal by applying a fast Fourier transform to each time frame of the plurality of time frames to determine a power spectrum of the frequency-domain audio signal; applying, by the one or more processors, a set of triangular Mel filters to the power spectrum to determine Mel filter energies of respective Mel filters of the set of triangular Mel filters; generating, by the one or more processors, a logarithmic Mel spectrum by applying a logarithmic function to the Mel filter energies; transforming, by the one or more processors, the logarithmic Mel spectrum into Mel-frequency cepstral coefficients by performing a discrete cosine transform of the logarithmic Mel spectrum; and generating, by the one or more processors, the Mel-frequency cepstral coefficient image as a matrix of the Mel-frequency cepstral coefficients of the each time frame.

In a further refinement, each time frame is between 5 milliseconds and 100 milliseconds.

In a further refinement, the matrix includes a two dimensional matrix.

In a further refinement, the matrix includes a first dimension of eighteen and a second dimension of sixty-four.

In a further refinement, the matrix includes a first dimension between 16 and 20.

In a further refinement, the matrix includes a second dimension between 60 and 70.

In a further refinement, a first set of rows (e.g., rows from zero to twelve) of the matrix indicate frequency-domain features and a second set of rows (e.g., rows thirteen to seventeen) of the matrix indicate time-domain features.

In a further refinement, the set of triangular Mel filters includes fifteen Mel filters.

In a further refinement, wherein Mel-frequency cepstral coefficients include thirteen Mel-frequency cepstral coefficients.

In a refinement, the time-domain audio signal is between 0.5 to 1.5 seconds in duration.

In a refinement, the time-domain audio signal includes a plurality of features.

In a further refinement, each feature, of the plurality of features, is represented by a feature vector having a length of sixty-four.

In a further refinement, the plurality of time-domain features includes one or more of: an average of an absolute value, a maximum deviation, a minimum deviation, a standard deviation, differences between consecutive elements of an average vector.

In a refinement, the CNN includes between one convolutional layer and four convolutional layers.

In a refinement, the CNN includes two convolutional layers.

In a further refinement, a first convolutional layer uses eight filters of a size 3 by 3.

In a further refinement, a first convolutional layer uses between four filters and sixteen filters.

In a further refinement, a first convolutional layer uses at least one filter of a size between 2 by 2 and 5 by 5.

In a further refinement, an output of a first convolutional layer retains spatial dimensions of an input of the first convolutional layer.

In a further refinement, a second convolutional layer uses four filters of size two by two.

In a further refinement, a second convolutional layer uses between two filters and eight filters.

In a further refinement, a second convolutional layer uses at least one filter of a size between 2 by 2 and 4 by 4.

In a further refinement, the two convolutional layers determine one or more hierarchical spatial features of the Mel-frequency cepstral coefficient image.

In a refinement, the CNN includes between two activation layers and six activation layers.

In a refinement, the CNN includes four activation layers.

In a further refinement, at least two activation layers of the four activation layers are rectified linear unit (ReLU) activation layers.

In a further refinement, at least two activation layers of the four activation layers include one or more of a leaky activation, an exponential linear unit activation, or a Tanh activation.

In a further refinement, a final activation layer of the four activation layers includes a sigmoid activation function applied to an output of a dense layer of the CNN.

In a further refinement, the final activation layer generates as an output a probability value between zero and one corresponding to a probability of the gunshot being captured in the audio.

In a refinement, the CNN includes between one max-pooling layer and three max-pooling layers.

In a refinement, the CNN includes two max-pooling layers.

In a further refinement, each of the two max-pooling layers are two-dimensional layers.

In a further refinement, at least one max-pooling layer of the two max-pooling layers is applied to down-sample a feature map output of an activation layer.

In a further refinement, the method further comprises: performing, by the one or more processors via the CNN, a down-sampling of a feature map output of an activation layer using average pooling.

In a further refinement, a first max-pooling layer reduces dimensions of a feature map output by a first activation layer from input feature map dimensions of (18, 64, 8) to output feature map dimensions of (9, 32, 8).

In a further refinement, a first max-pooling layer reduces dimensions of a feature map output by a first activation layer, the feature map having input feature map dimensions when input into the first max-pooling layer including a first feature map input dimension between 16 and 20, a second feature map input dimension between 60 and 70, and a third feature map input dimension between 6 and 10.

In a further refinement, a first max-pooling layer reduces dimensions of a feature map output by a first activation layer, the feature map having output feature map dimensions when output by the first max-pooling layer including a first output feature map dimension between 8 and 10, a second output feature map dimension between 30 and 35, and a third output feature map dimension between 6 and 10.

In a further refinement, a second max-pooling layer reduces dimensions of a feature map output by a second activation layer from (9, 32, 4) to (4, 16, 4).

In a further refinement, a second max-pooling layer reduces dimensions of a feature map output by a second activation layer, the feature map having input feature map dimensions when input into the second max-pooling layer including a first feature map input dimension between 8 and 10, a second feature map input dimension between 30 and 35, and a third feature map input dimension between 3 and 6.

In a further refinement, a second max-pooling layer reduces dimensions of a feature map output by a second activation layer, the feature map having output feature map dimensions when output by the second max-pooling layer including a first feature map output dimension between 3 and 5, a second feature map output dimension between 15 and 20, and a third feature map input dimension between 3 and 6.

In a refinement, the CNN includes at least one flatten layer.

In a refinement, the CNN includes a global pooling layer.

In a refinement, the CNN includes one flatten layer.

In a further refinement, the one flatten layer flattens a second max-pooling layer into a one-dimensional vector of a size 256.

In a further refinement, the one flatten layer flattens a second max-pooling layer into a one-dimensional vector of a size between 100 and 2,500.

In a refinement, the CNN includes two dense layers.

In a further refinement, a vector output by a flattened layer is passed through a first dense layer with eight neurons, followed by a ReLU activation function.

In a further refinement, a vector output by a flattened layer is passed through a first dense layer having between four neurons and sixteen neurons.

In a further refinement, a second dense layer includes one neuron that outputs a single value for binary classification.

In a further refinement, a second dense layer includes at least one neuron performing multiclass classification.

In a refinement, the CNN includes one or more dropout layer, each dropout layer of the one or more dropout layers including a dropout rate between 0.1 and 0.5.

In a refinement, the CNN includes one dropout layer.

In a further refinement, the one dropout layer includes a dropout rate of 0.2.

In a further refinement, the one dropout layer is applied to an output of a flatten layer.

In a further refinement, the one dropout layer randomly sets 20% of neurons of the CNN to zero during each training iteration.

In a refinement, the CNN includes 2277 parameters.

In a refinement, the CNN includes between 2,000 parameters and 3,000 parameters.

In a refinement, the CNN is trained using training data.

In a further refinement, the method further comprises: generating the training data based upon an original set of gunshots sounds, wherein the training data indicates the original set of gunshot sounds.

In a further refinement, the original set of gunshot sounds includes 300 gunshots sounds.

In a further refinement, the method further comprises: generating a second set of gunshot sounds based upon at least a portion of the original set of gunshot sounds by modifying at least the portion of the original set of gunshot sounds.

In a further refinement, modifying at least the portion of the original set of gunshot sounds includes one or more of: time shifting the audio (e.g. forward or backward), applying a location effect to the audio (e.g., auditorium, bathroom, hanger), applying an echo effect to the audio; altering a phaser effect to the audio, applying an equalizer effect to the audio, applying a flanger effect to the audio, applying a tremolo effect to the audio, applying a vibrato effect to the audio, applying a distortion effect to the audio, applying a chorus effect to the audio, applying a reverberation effect to the audio, or overlaying a non-gunshot sound onto the gunshot sound.

In a further refinement, the training data include non-gunshot sounds includes one or more of screaming, playing ringtones, music, game sounds from a computing device, dropping objects, talking, laughing, clapping, a school bell, a verbal announcement, balloon pop, basketball bouncing, coffee shop ambiance, fire siren, footsteps, highway sounds, TV ambiance, rain, thunderstorm, party noise, power tools, vacuum, classroom music, radio ambiance, school cafeteria ambiance, school hallway ambiance between classes, sliding door opening and closing, smoke alarm, video game, whistles and horns, or a noisy classroom.

In a further refinement, the training data indicates 75,000-80,000 gunshot sounds.

In a further refinement, the training data indicates 80,000-100,000 non-gunshot sounds.

In a further refinement, the training data includes 150,000-200,000 Mel-frequency cepstral coefficient images.

In a further refinement, the training data includes a first subset of data for training, a second subset of data for validation, and a third subset of data for testing.

In a refinement, the detection notification includes one or more of: at least a portion of the audio captured proximate to the gunshot (e.g., 5-30 sec, 10-20 sec); a timestamp; or a location of the detection device.

In a refinement, the method further comprises: transmitting the detection notification from the computing device (e.g., central server/database) to one or more client devices (e.g., smart phone, tablet, desktop computer, laptop computer etc. with software/hardware to wirelessly receive the detection notification).

In a further refinement, the one or more client devices are selected from the group consisting of employee client devices (e.g., employees of an entity where the detection device is physically located), security client devices (e.g., security personnel responsible for the location where the detection device is physically located), law enforcement client devices, and combinations thereof.

In a further refinement, the method further comprises: receiving at the computing device a confirmation notification from a client device, the confirmation notification indicating that the detection notification is a valid gunshot detection or a false positive gunshot detection.

In a further refinement, the method further comprises: transmitting the confirmation notification from the computing device to the one or more client devices (e.g., other than that which provided the confirmation notification).

In a further refinement, the detection notification includes one or more of: at least a portion of the audio captured proximate to the gunshot (e.g., 5-30 sec, 10-20 sec); a timestamp; or a location of the detection device.

In a refinement, the method further comprises: transmitting the detection notification from the computing device to one or more law enforcement client devices along with a request for law enforcement intervention at the environment of the detection device.

In a refinement, the environment is selected from the group consisting of a school building, a private (business) building, a public building, and a government building (e.g., an indoor location in the various buildings).

In a refinement, the method further comprises: downsampling, by the one or more processors, at least a portion of the audio before transmitting at least the portion of the audio to the computing device.

In a refinement, the method further comprises: determining, via the one or more processors, whether additional sounds indicative of the gunshot are captured in the audio by applying the CNN to the Mel-frequency cepstral coefficient image, wherein additional sounds do not include the sound of the gunshot; and responsive to determining the additional sounds indicative of the gunshot are captured in the audio, transmitting, via the detection device, the detection notification to the computing device.

In a further refinement, the additional sounds include one or more of: screaming, crying, or shouting.

In a further refinement, the additional sounds are captured proximate to the gunshot.

In a refinement, the method further comprises: sending a lock command to doors or rooms in the environment. For example, the disclosed system can automate the lockdown process in a school or other building by sending commands to the door locks of the classrooms as soon as a gun is detected and this will save time and effort in implementing the ALICE protocol (Alert, Lockdown, Inform, Counter, and Evacuate).

In a refinement, the method further comprises: sending an announcement over a public address (PA) system in the environment. For example, the disclosed system can automatically announce using the PA system the location of where the gun is detected and also announce to move away from that area. For instance, if the gun is detected in the northside hallway, the people who are outside the classrooms will be automatically advised using the PA system to move towards the south. This is the current practice in schools, and automating this can save time and lives.

In another aspect, the disclosure relates to a system for real-time detection of a gunshot, the system comprising: a (centralized) computing device (e.g., a remote/cloud server/database); and at least one detection device comprising: an audio sensor configured to capture audio comprising a time-domain audio signal of an environment of the at least one detection device, and a convolutional neural network (CNN) stored on one or more non-transitory memories and configured to determine a sound of the gunshot based upon a Mel-frequency cepstral coefficient image, wherein the at least one detection device is configured to: transform the time-domain audio signal into a Mel-frequency cepstral coefficient image, and responsive to determining the sound of the gunshot is captured in the audio via the CNN, transmit a detection notification to the (centralized) computing device.

In a refinement, the system further comprises: at least one client device comprising: one or more processors, and one or more non-transitory memories storing processor executable instructions that, when executed by the one or more processors, cause the at least one client device to: (wirelessly) receive a detection notification from the (centralized) computing device, and/or (wirelessly) transmit a confirmation notification to the (centralized) computing device indicating that the detection notification is a valid gunshot detection or a false positive gunshot detection.

In another aspect, the disclosure relates to a method for real-time response to a gunshot detection, the method comprising: receiving from a system as disclosed herein a detection notification that a gunshot has been detected by a detection device in the system; and dispatching a law enforcement response at the environment of the detection device.

In another aspect, the disclosure relates to a non-transitory computer-readable medium storing processor-executable instructions that, when executed by one or more processors, cause the one or more processors to at least: capture audio of an environment, the captured audio comprising a time-domain audio signal; transform the time-domain audio signal into a Mel-frequency cepstral coefficient image; determine whether a sound of a gunshot is captured in the audio by applying a convolutional neural network (CNN) to the Mel-frequency cepstral coefficient image; and responsive to determining the sound of the gunshot is captured in the audio, transmit a detection notification to a computing device.

In another aspect, the disclosure relates to a detection device configured for real-time detection of a gunshot, the detection device comprising: an audio sensor configured to capture audio comprising a time-domain audio signal of an environment of the detection device; and a convolutional neural network (CNN) stored on one or more non-transitory memories and configured to determine a sound of the gunshot based upon a Mel-frequency cepstral coefficient image, wherein the detection device is configured to: transform the time-domain audio signal into a Mel-frequency cepstral coefficient image, and responsive to determining the sound of the gunshot is captured in the audio via the CNN, transmit a detection notification to a centralized computing device.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### REFERENCES

1. Samireddy, S. R.; Carletta, J.; Lee, K. An embeddable algorithm for gunshot detection. In Proceedings of the 2017 IEEE 60th International Midwest Symposium on Circuits and Systems (MWSCAS), Boston, MA, USA, 6-9 Aug. 2017; pp. 68-71.
2. Thanhikam, W. Gunshot noise detection using zero phase technique. In Proceedings of the 2015 Asian Conference on Defence Technology (ACDT), Hua Hin, Thailand, 23-25 Apr. 2015; pp. 183-186.
3. Hrabina, M.; Sigmund, M. Gunshot recognition using low level features in the time domain. In Proceedings of the 2018 28th International Conference Radioelektronika (RADIOELEKTRONIKA), Prague, Czech Republic, 19-20 Apr. 2018; pp. 1-5.
4. Lopez-Morillas, J.; Canadas-Quesada, F. J.; Vera-Candeas, P.; Ruiz-Reyes, N.; Mata-Campos, R.; Montiel-Zafra, V. Gunshot detection and localization based on Non-negative Matrix Factorization and SRP-Phat. In Proceedings of the 2016 IEEE Sensor Array and Multichannel Signal Processing Workshop (SAM), Rio de Janeiro, Brazil, 10-13 Jul. 2016; pp. 1-5.
5. Valenzise, G.; Gerosa, L.; Tagliasacchi, M.; Antonacci, F.; Sarti, A. Scream and gunshot detection and localization for audio-surveillance systems. In Proceedings of the 2007 IEEE Conference on Advanced Video and Signal Based Surveillance, London, UK, 5-7 Sep. 2007; pp. 21-26.
6. Chen, C.; Abdallah, A.; Wolf, W. Audiovisual Gunshot Event Recognition. In Proceedings of the 2006 IEEE International Conference on Systems, Man and Cybernetics, Taipei, Taiwan, 8-11 Oct. 2006; pp. 4807-4812.
7. Galangque, C. M. J.; Guirnaldo, S. A. Gunshot Classification and Localization System using Artificial Neural Network (ANN). In Proceedings of the 2019 12th International Conference on Information & Communication Technology and System (ICTS), Surabaya, Indonesia, 18 Jul. 2019; pp. 1-5.
8. Bajzik, J.; Prinosil, J.; Koniar, D. Gunshot Detection Using Convolutional Neural Networks. In Proceedings of the 2020 24th International Conference Electronics, Palanga, Lithuania, 15-17 Jun. 2020; pp. 1-5.
9. Morehead, A.; Ogden, L.; Magee, G.; Hosler, R.; White, B.; Mohler, G. Low Cost Gunshot Detection using Deep Learning on the Raspberry Pi. In Proceedings of the 2019 IEEE International Conference on Big Data (Big Data), Los Angeles, CA, USA, 9-12 Dec. 2019; pp. 3038-3044.

What is claimed is:

1. A method for real-time detection of a gunshot, the method comprising:
capturing, via a detection device, audio of an environment of the detection device, the captured audio comprising a time-domain audio signal;
transforming, via one or more processors of the detection device, the time-domain audio signal into a Mel-frequency cepstral coefficient image;
determining, via the one or more processors, whether a sound of the gunshot is captured in the audio by applying a convolutional neural network (CNN) to the Mel-frequency cepstral coefficient image; and
responsive to determining the sound of the gunshot is captured in the audio, transmitting, via the detection device, a detection notification to a computing device.

2. The method claim 1, wherein transforming the time-domain audio signal into the Mel-frequency cepstral coefficient image comprises:
partitioning, by the one or more processors, the time-domain audio signal into a plurality of time frames;
transforming, by the one or more processors, the time-domain audio signal into a frequency-domain audio signal by applying a fast Fourier transform to each time frame of the plurality of time frames to determine a power spectrum of the frequency-domain audio signal;
applying, by the one or more processors, a set of triangular Mel filters to the power spectrum to determine Mel filter energies of respective Mel filters of the set of triangular Mel filters;
generating, by the one or more processors, a logarithmic Mel spectrum by applying a logarithmic function to the Mel filter energies;
transforming, by the one or more processors, the logarithmic Mel spectrum into Mel-frequency cepstral coefficients by performing a discrete cosine transform of the logarithmic Mel spectrum; and
generating, by the one or more processors, the Mel-frequency cepstral coefficient image as a matrix of the Mel-frequency cepstral coefficients of the each time frame.

3. The method claim 2, wherein:
each time frame is between 5 milliseconds and 100 milliseconds;
the matrix includes a two dimensional matrix including a first dimension between 16 and 20 and a second dimension between 60 and 70;
a first set of rows of the matrix indicate frequency-domain features and a second set of rows of the matrix indicate time-domain features;
the set of triangular Mel filters includes fifteen Mel filters; and
the Mel-frequency cepstral coefficients include thirteen Mel-frequency cepstral coefficients.

4. The method claim 1, wherein:
the time-domain audio signal is between 0.5 to 1.5 seconds in duration;
the time-domain audio signal includes a plurality of features;
each feature, of the plurality of features, is represented by a feature vector having a length of sixty-four; and
the plurality of time-domain features includes one or more of: an average of an absolute value, a maximum deviation, a minimum deviation, a standard deviation, differences between consecutive elements of an average vector.

5. The method claim 1, wherein:
the CNN includes two convolutional layers;
a first convolutional layer uses between four filters and sixteen filters;
the first convolutional layer uses at least one filter of a size between 2 by 2 and 5 by 5;
an output of a first convolutional layer retains spatial dimensions of an input of the first convolutional layer;
a second convolutional layer uses between two filters and eight filters;
the second convolutional layer uses at least one filter of a size between 2 by 2 and 4 by 4; and
the two convolutional layers determine one or more hierarchical spatial features of the Mel-frequency cepstral coefficient image.

6. The method claim 1, wherein:
the CNN includes four activation layers;
at least two activation layers of the four activation layers are rectified linear unit (ReLU) activation layers;
at least two activation layers of the four activation layers include one or more of a leaky activation, an exponential linear unit activation, or a Tanh activation;
a final activation layer of the four activation layers includes a sigmoid activation function applied to an output of a dense layer of the CNN; and
the final activation layer generates as an output a probability value between zero and one corresponding to a probability of the gunshot being captured in the audio.

7. The method claim 1, wherein:
the CNN includes two max-pooling layers;
each of the two max-pooling layers are two-dimensional layers;
at least one max-pooling layer of the two max-pooling layers is applied to down-sample a feature map output of an activation layer;
the method further comprises performing, by the one or more processors via the CNN, a down-sampling of a feature map output of an activation layer using average pooling;
a first max-pooling layer reduces dimensions of a feature map output by a first activation layer, the feature map having input feature map dimensions when input into the first max-pooling layer including a first feature map input dimension between 16 and 20, a second feature map input dimension between 60 and 70, and a third feature map input dimension between 6 and 10;
the first max-pooling layer reduces dimensions of a feature map output by a first activation layer, the feature map having output feature map dimensions when output by the first max-pooling layer including a first output feature map dimension between 8 and 10, a second output feature map dimension between 30 and 35, and a third output feature map dimension between 6 and 10;
a second max-pooling layer reduces dimensions of a feature map output by a second activation layer, the feature map having input feature map dimensions when input into the second max-pooling layer including a first feature map input dimension between 8 and 10, a second feature map input dimension between 30 and 35, and a third feature map input dimension between 3 and 6; and
the second max-pooling layer reduces dimensions of a feature map output by a second activation layer, the feature map having output feature map dimensions when output by the second max-pooling layer including a first feature map output dimension between 3 and 5, a second feature map output dimension between 15 and 20, and a third feature map input dimension between 3 and 6.

8. The method claim 1, wherein:
the CNN includes one flatten layer;
the CNN includes a global pooling layer;
the one flatten layer flattens a second max-pooling layer into a one-dimensional vector of a size between 100 and 2,500;
the CNN includes two dense layers;
a vector output by a flattened layer is passed through a first dense layer having between four neurons and sixteen neurons;
a second dense layer includes one neuron that outputs a single value for binary classification;
a second dense layer includes at least one neuron performing multiclass classification;
the CNN includes one dropout layer;
the one dropout layer includes a dropout rate of 0.2;
the one dropout layer is applied to an output of a flatten layer;
the one dropout layer randomly sets 20% of neurons of the CNN to zero during each training iteration; and
the CNN includes between 2,000 parameters and 3,000 parameters.

9. The method claim 1, wherein:
the CNN is trained using training data;
the method further comprises:
generating the training data based upon an original set of gunshots sounds, wherein the training data indicates the original set of gunshot sounds; and
generating a second set of gunshot sounds based upon at least a portion of the original set of gunshot sounds by modifying at least the portion of the original set of gunshot sounds by performing one or more of: time shifting the audio, applying a location effect to the audio, applying an echo effect to the audio, altering a phaser effect to the audio, applying an equalizer effect to the audio, applying a flanger effect to the audio, applying a tremolo effect to the audio, applying a vibrato effect to the audio, applying a distortion effect to the audio, applying a chorus effect to the audio, applying a reverberation effect to the audio, or overlaying a non-gunshot sound onto the gunshot sound;
the training data include non-gunshot sounds including one or more of screaming, playing ringtones, music, game sounds from a computing device, dropping objects, talking, laughing, clapping, a school bell, a verbal announcement, balloon pop, basketball bouncing, coffee shop ambiance, fire siren, footsteps, highway sounds, TV ambiance, rain, thunderstorm, party noise, power tools, vacuum, classroom music, radio ambiance, school cafeteria ambiance, school hallway ambiance between classes, sliding door opening and closing, smoke alarm, video game, whistles and horns, or a noisy classroom;
the training data indicates 75,000-80,000 gunshot sounds;
the training data indicates 80,000-100,000 non-gunshot sounds;
the training data includes 150,000-200,000 Mel-frequency cepstral coefficient images; and
the training data includes a first subset of data for training, a second subset of data for validation, and a third subset of data for testing.

10. The method claim 1, wherein the detection notification comprises at least a portion of the audio captured proximate to the gunshot; a timestamp for the audio captured;
and a location of the detection device.

11. The method claim 1, further comprising:
transmitting the detection notification from the computing device to one or more client devices selected from the group consisting of employee client devices, security client devices, law enforcement client devices, and combinations thereof;
receiving at the computing device a confirmation notification from a client device, the confirmation notification indicating that the detection notification is a valid gunshot detection or a false positive gunshot detection; and
transmitting the confirmation notification from the computing device to the one or more client devices.

12. The method claim 1, further comprising:
transmitting the detection notification from the computing device to one or more law enforcement client devices along with a request for law enforcement intervention at the environment of the detection device;
wherein the environment is an indoor location selected from the group consisting of a school building, a private building, a public building, and a government building.

13. The method claim 1, further comprising:
downsampling, by the one or more processors, at least a portion of the audio before transmitting at least the portion of the audio to the computing device; and
determining, via the one or more processors, whether additional sounds indicative of the gunshot are captured in the audio by applying the CNN to the Mel-frequency cepstral coefficient image, wherein additional sounds do not include the sound of the gunshot; and responsive to determining the additional sounds indicative of the gunshot are captured in the audio, transmitting, via the detection device, the detection notification to the computing device;
wherein:
the additional sounds include one or more of: screaming, crying, or shouting; and
the additional sounds are captured proximate to the gunshot.

14. The method claim 1, further comprising:
sending a lock command to doors or rooms in the environment.

15. The method claim 1, further comprising:
sending an announcement over a public address (PA) system in the environment.

16. A system for real-time detection of a gunshot, the system comprising:
a computing device; and
at least one detection device comprising:
an audio sensor configured to capture audio comprising a time-domain audio signal of an environment of the at least one detection device, and
a convolutional neural network (CNN) stored on one or more non-transitory memories and configured to determine a sound of the gunshot based upon a Mel-frequency cepstral coefficient image,
wherein the at least one detection device is configured to:
transform the time-domain audio signal into a Mel-frequency cepstral coefficient image, and
responsive to determining the sound of the gunshot is captured in the audio via the CNN, transmit a detection notification to the computing device.

17. The system claim 16, further comprising:
at least one client device comprising: one or more processors, and one or more non-transitory memories storing processor executable instructions that, when executed by the one or more processors, cause the at least one client device to:
receive a detection notification from the computing device, and/or
transmit a confirmation notification to the computing device indicating that the detection notification is a valid gunshot detection or a false positive gunshot detection.

18. A method for real-time response to a gunshot detection, the method comprising:
receiving from the system of claim 16 a detection notification that a gunshot has been detected by a detection device in the system; and
dispatching a law enforcement response at the environment of the detection device.

19. A non-transitory computer-readable medium storing processor-executable instructions that, when executed by one or more processors, cause the one or more processors to at least:
capture audio of an environment, the captured audio comprising a time-domain audio signal;
transform the time-domain audio signal into a Mel-frequency cepstral coefficient image;
determine whether a sound of a gunshot is captured in the audio by applying a convolutional neural network (CNN) to the Mel-frequency cepstral coefficient image; and
responsive to determining the sound of the gunshot is captured in the audio, transmit a detection notification to a computing device.

20. A detection device configured for real-time detection of a gunshot, the detection device comprising:
an audio sensor configured to capture audio comprising a time-domain audio signal of an environment of the detection device; and
a convolutional neural network (CNN) stored on one or more non-transitory memories and configured to determine a sound of the gunshot based upon a Mel-frequency cepstral coefficient image,
wherein the detection device is configured to:
transform the time-domain audio signal into a Mel-frequency cepstral coefficient image, and
responsive to determining the sound of the gunshot is captured in the audio via the CNN, transmit a detection notification to a centralized computing device.
